(19) United States
(12) Patent Application Publication
(10) Pub. No.: US 2023/0315695 A1
(43) Pub. Date: Oct. 5, 2023

(54) BYTE-ADDRESSABLE JOURNAL HOSTED USING BLOCK STORAGE DEVICE

(71) Applicant: NetApp Inc., San Jose, CA (US)

(72) Inventors: Asif Imtiyaz Pathan, San Jose, CA (US); Parag Sarfare, San Jose, CA (US); Amit Borase, San Mateo, CA (US)

(21) Appl. No.: 17/710,638

(22) Filed: Mar. 31, 2022

(51) Int. Cl. G06F 16/18; G06F 16/182; G06F 16/172; G06F 16/178

(52) U.S. Cl. CPC G06F 16/1815; G06F 16/1824; G06F 16/172; G06F 16/178

(57) ABSTRACT

Techniques are provided for implementing a journal using a block storage device for a plurality of clients. A journal may be hosted as a primary cache for a node, where I/O operations of a plurality of clients are logged within the journal. The node may be part of a distributed cluster of nodes hosted within a container orchestration platform. The journal may be stored in a storage device comprising a block storage device and a cache. Adaptive caching may be implemented to store some journal data of the journal in the cache. For example, a first set of journal data may be stored in the block storage device without storing the first set of journal data in the cache. A second set of journal data may be stored in the block storage device and the cache.

### TECHNICAL FIELD

Various embodiments of the present technology generally relate to managing data using a distributed file system. More specifically, some embodiments relate to methods and systems for managing data using a distributed file system that utilizes a block storage device for journaling.

### BACKGROUND

Historically, developers built inflexible, monolithic applications designed to be run on a single platform. However, building a monolithic application is no longer desirable in most instances as many modern applications often need to efficiently, and securely, scale (potentially across multiple platforms) based upon demand. There are many options for developing scalable, modern applications. Examples include, but are not limited to, virtual machines, microservices, and containers. The choice often depends on a variety of factors such as the type of workload, available ecosystem resources, need for automated scaling, and/or execution preferences.

When developers select a containerized approach for creating scalable applications, portions (e.g., microservices, larger services, etc.) of the application are packaged into containers. Each container may comprise software code, binaries, system libraries, dependencies, system tools, and/or any other components or settings needed to execute the application. In this way, the container is a self-contained execution enclosure for executing that portion of the application.

Unlike virtual machines, containers do not include operating system images. Instead, containers ride on a host operating system which is often light weight allowing for faster boot and utilization of less memory than a virtual machine. The containers can be individually replicated and scaled to accommodate demand. Management of the container (e.g., scaling, deployment, upgrading, health monitoring, etc.) is often automated by a container orchestration platform (e.g., Kubernetes).

The container orchestration platform can deploy containers on nodes (e.g., a virtual machine, physical hardware, etc.) that have allocated compute resources (e.g., processor, memory, etc.) for executing applications hosted within containers. Applications (or processes) hosted within multiple containers may interact with one another and cooperate together. For example, a storage application within a container may access a deduplication application and a compression application within other containers in order to deduplicate and/or compress data managed by the storage application. Container orchestration platforms often offer the ability to support these cooperating applications (or processes) as a grouping (e.g., in Kubernetes this is referred to as a pod). This grouping (e.g., a pod) can support multiple containers and forms a cohesive unit of service for the applications (or services) hosted within the containers. Containers that are part of a pod may be co-located and scheduled on a same node, such as the same physical hardware or virtual machine. This allows the containers to share resources and dependencies, communicate with one another, and/or coordinate their lifecycles of how and when the containers are terminated.

### SUMMARY

Various embodiments of the present technology generally relate to managing data using a distributed file system. More specifically, some embodiments relate to methods and systems for managing data using a distributed file system that utilizes a block storage device for journaling.

According to some embodiments, a storage system is provided. The storage system comprises a node of a distributed cluster of nodes hosted within a container orchestration platform. The node is configured to store data across distributed storage managed by the distributed cluster of nodes. The storage system may comprise a journal hosted as a primary cache for the node. A plurality of input/output (I/O) operations of a plurality of clients may be logged within the journal. A storage device may be configured to store the journal as the primary cache. The storage device may comprise a block storage device and a cache. A storage management system, of the storage system, may be configured to store a first set of journal data, indicative of a first I/O operation of the plurality of I/O operations, in the block storage device without storing the first set of journal data in the cache. The storage management system may be configured to store a second set of journal data, indicative of a second I/O operation of the plurality of I/O operations, in the block storage device and the cache.

The storage management system may be configured to determine one or more characteristics associated with the first set of journal data. The one or more characteristics may comprise a type of I/O operation of the first I/O operation, a size of the first set of journal data and/or a client, of the plurality of clients, associated with the first I/O operation. The storage management system may make a determination not to store the first set of journal data in the cache based upon the one or more characteristics. The storage management system may use the one or more characteristics to make a determination of whether or not to store the first set of journal data in the cache when a sync transfer mode (e.g., a sync Direct Memory Access (DMA) transfer mode) is implemented for transferring sets of data to the journal.

The storage management system may be configured to determine one or more characteristics associated with the second set of journal data. The one or more characteristics may comprise a type of I/O operation of the second I/O operation, a size of the second set of journal data and/or a client, of the plurality of clients, associated with the second I/O operation. The storage management system may make a determination to store the second set of journal data in the block storage device and in the cache based upon the one or more characteristics. The storage management system may use the one or more characteristics to make a determination of whether or not to store the second set of journal data in the cache when a sync transfer mode (e.g., a sync DMA transfer mode) is implemented for transferring sets of data to the journal.

The storage management system may be configured to determine a status of a region, of the block storage device, in which the first set of journal data is stored. The storage management system may make a determination not to store the first set of journal data in the cache based upon the status being dormant. The storage management system may use the status to make a determination of whether or not to store the first set of journal data in the cache when an async transfer mode (e.g., an async DMA transfer mode) is implemented for transferring sets of data to the journal.

The storage management system may be configured to determine a status of a region, of the block storage device, in which the second set of journal data is stored. The storage management system may make a determination to store the second set of journal data in the cache based upon the status being active. The storage management system may use the status to make a determination of whether or not to store the second set of journal data in the cache when an async transfer mode (e.g., an async DMA transfer mode) is implemented for transferring sets of data to the journal.

According to some embodiments, the storage system comprises a data management system configured to implement a plurality of flushing threads to facilitate concurrent data transfers from clients of the plurality of clients to the journal.

According to some embodiments, the storage device is configured to store a persistent key-value store. Data may be cached as key-value record pairs within the persistent key-value store for read and write access until written in a distributed manner across the distributed storage.

According to some embodiments, the storage system comprises space management functionality configured to track metrics associated with storage utilization by the journal and/or the persistent key-value store. The metrics may be used to determine when to store data from the journal to storage.

According to some embodiments, a journal may be hosted, on a storage device, as a primary cache for a node of a distributed cluster of nodes hosted within a container orchestration platform. The node is configured to store data across distributed storage managed by the distributed cluster of nodes. The storage device comprises a block storage device and a cache. A plurality of I/O operations of a plurality of clients may be logged within the journal. A first status of a first region, of the block storage device, in which a first set of journal data of the journal is stored may be determined. The first set of journal data is indicative of a first I/O operation of the plurality of I/O operations. The first set of journal data may be stored in the cache based upon the first status being active. Byte-addressable access to the first set of journal data of the journal may be provided when the first set of journal data is stored in the cache.

A second status of a second region, of the block storage device, in which a second set of journal data of the journal is stored may be determined. A determination not to store the second set of journal data in the cache may be made based upon the second status being dormant.

The first status may be used to make a determination of whether or not to store the first set of journal data in the cache when an async transfer mode (e.g., an async DMA transfer mode) is implemented for transferring sets of data to the journal.

Concurrent data transfers, from clients of the plurality of clients to the journal, may be facilitated using a plurality of flushing threads implemented by a data management system.

According to some embodiments, a journal may be hosted, on a storage device, as a primary cache for a node of a distributed cluster of nodes hosted within a container orchestration platform. The node is configured to store data across distributed storage managed by the distributed cluster of nodes. The storage device comprises a block storage device and a cache. A plurality of I/O operations of a plurality of clients may be logged within the journal. One or more characteristics associated with a first I/O operation to be logged in the journal may be determined. The one or more characteristics may comprise a type of I/O operation of the first I/O operation, a size of the first set of journal data and/or a client, of the plurality of clients, associated with the first I/O operation. The first set of journal data may be stored in the cache and the block storage device based upon the one or more characteristics. Byte-addressable access to the first set of journal data of the journal may be provided when the first set of journal data is stored in the cache.

One or more second characteristics, associated with a second I/O operation to be logged in the journal, may be determined. The one or more second characteristics may comprise a second type of I/O operation of the second I/O operation, a second size of a second set of journal data indicative of the second I/O operation and/or a second client, of the plurality of clients, associated with the second I/O operation. Based upon the one or more second characteristics, a determination may be made to store the second set of journal data in the block storage device and not to store the second set of journal data in the cache.

The one or more characteristics may be used to make a determination of whether or not to store the first set of journal data in the cache when a sync transfer mode (e.g., a sync DMA transfer mode) is implemented for transferring sets of data to the journal.

The first set of journal data may be stored in the cache and the block storage device based upon a determination that the size of the first set of journal data is smaller than a threshold size.

### DESCRIPTION OF THE DRAWINGS

Embodiments of the present technology will be described and explained through the use of the accompanying drawings in which:

FIG. 1A is a block diagram illustrating an example of various components of a composable, service-based distributed storage architecture in accordance with various embodiments of the present technology.

FIG. 1B is a block diagram illustrating an example of a node (e.g., a Kubernetes worker node) in accordance with various embodiments of the present technology.

FIG. 1C is a block diagram illustrating an example of multiple paths through which multiple central processing units (CPUs) can concurrently issue data transfers to store data in a storage device in accordance with various embodiments of the present technology.

FIG. 2 is a flow chart illustrating an example of a set of operations that can be used for implementing a journal for a plurality of clients using a block storage device in accordance with various embodiments of the present technology.

FIG. 3A is a flow chart illustrating an example of a set of operations for implementing region status-based adaptive caching for storing journal data, of a journal, in a cache in accordance with various embodiments of the present technology.

FIG. 3B is a flow chart illustrating an example of a set of operations for implementing characteristics-based adaptive caching for storing journal data, of a journal, in a cache in accordance with various embodiments of the present technology.

FIG. 3C is a flow chart illustrating an example of a set of operations for implementing adaptive caching for storing journal data, of a journal, in a cache in accordance with various embodiments of the present technology.

FIG. 4 is a block diagram illustrating an example of a network environment with exemplary nodes in accordance with various embodiments of the present technology.

FIG. 5 is a block diagram illustrating an example of various components that may be present within a node that may be used in accordance with various embodiments of the present technology.

FIG. 6 is an example of a computer readable medium in which various embodiments of the present technology may be implemented.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The techniques described herein are directed to implementing a journal using a block storage device for a plurality of clients. The demands on data center infrastructure and storage are changing as more and more data centers are transforming into private and hybrid clouds. Storage solution customers are looking for solutions that can provide automated deployment and lifecycle management, scaling on-demand, higher levels of resiliency with increased scale, and automatic failure detection and self-healing. To meet these objectives, a container-based distributed storage architecture can be leveraged to create a composable, service-based architecture that provides scalability, resiliency, and load balancing. The container-based distributed storage management system may include one or more clusters and a distributed file system that is implemented for each cluster or across the one or more clusters. The distributed file system may provide a scalable, resilient, software defined architecture that can be leveraged to be the data plane for existing as well as new web scale applications.

A journal may be used to log input/output (I/O) operations of a plurality of clients of the distributed storage architecture. For example, when a client performs an I/O operation (e.g., a modify operation, a write operation, a metadata operation, a configure operation, a hole punching operation, a cloning operation, and/or other type of I/O operation), the I/O operation may be logged in the journal by storing a set of journal data (e.g., a journal entry) in a storage device in which the journal is stored. A block storage device may be used as the storage device to store the journal. In order to provide clients with byte-addressable access to the journal, some systems use full-scale memory backing of the block storage device. Full-scale memory backing can be done, for example, by caching the entirety of the journal in a cache to be able to present the journal to clients in a byte-addressable manner without requiring performance of read-modify-writes. However, this may require large amounts of resources. For example, the block storage device may be a large block storage device (e.g., the block storage device may have over 10 gigabytes (GB) of storage space, over 100 GB and/or over 1 terabyte (TB) of storage space) and/or the journal may occupy a large amount of storage space on the block storage device (e.g., over 10 GB, over 100 GB and/or over 1 TB). Accordingly, especially in cases in which the block storage device is a large block storage device and/or the journal occupies a large amount of storage space, implementing full-scale memory backing of the block storage device may require considerable processing and/or memory resource usage, and/or may require a large amount of backing memory (e.g., memory of the cache) to cache the entirety of the journal (e.g., in an scenario in which the journal takes up 1 TB of storage space and/or the block storage device has 1 TB of storage space, the backing memory may be required to have 1 TB of storage space for caching the journal).

In contrast, various embodiments of the present technology utilize adaptive caching to implement sub-linear scaling of memory resources in which merely a subset of the journal may be cached in the cache to be able to present the journal to clients in a byte-addressable manner. For example, at least some journal data of the journal data may be stored in both the block storage device and the cache, while at least some journal data of the journal may be stored in the block storage device without being stored in the cache. Byte-addressable access to journal data may be provided when the journal data is stored in the cache. For example, by storing journal data in the cache, read I/O operations and/or write I/O operations may be performed upon the journal without requiring performance of costly read-modify-writes, thereby avoiding delays associated with read-modify-writes. At least a portion of the journal may be presented (to clients, for example) as a byte-addressable journal without requiring that the entirety of the journal be cached in the cache (such that a client may perceive the journal to be a byte-addressable journal, for example), thereby providing for a reduced amount journal data cached in the cache and/or a reduced amount of memory resources used by the journal. For example, as a result of using one or more of the techniques herein to implement adaptive caching for caching journal data in the cache, the amount of backing memory (e.g., memory of the cache) used for caching journal data of the journal may be reduced by a significant amount (e.g., about 90% in some cases). In this way, memory resource requirements of the cache may be reduced such that a smaller and/or less costly cache can be used. Alternatively and/or additionally, by reducing the amount of memory resources of the cache used to cache journal data, more memory resources of the cache may be available for other purposes with faster computer processing, improved performance, etc.

Various embodiments of the present technology provide for a wide range of technical effects, advantages, and/or improvements to computing systems and components. For example, various embodiments may include one or more of the following technical effects, advantages, and/or improvements: 1) implementation of a journal using a block storage device and a cache to provide clients with byte-addressable access to the journal without requiring performance of read-modify-writes to improve performance, reduce latency and/or avoid delays; 2) use of non-routine and unconventional operations to cache journal data in the cache in an adaptive manner to reduce an amount of memory resource usage of the cache and/or improve performance of the cache and/or the journal; 3) use of non-routine and unconventional operations to facilitate concurrent data transfers to the journal via a plurality of flushing threads to avoid batching, avoid asynchronous flushing, avoid polling delays, reduce latency, and/or increase flushing throughput to storage in which the journal is stored; 4) enabling usage of a large block device for storing the journal without requiring a large amount of backing memory (e.g., memory of a cache) for the large block device and/or without changing the manner in which clients can use the journal as a byte-addressable journal such that the clients can continue to treat the journal as byte-addressable; and/or 5) enabling multiple central processing units (CPUs) to independently and/or concurrently issue data transfers to persist data for reduced latency and/or improved performance, etc.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. While, for convenience, embodiments of the present technology are described with reference to a distributed storage architecture and container orchestration platform (e.g., Kubernetes), embodiments of the present technology are equally applicable to various other computing environments such as, but not limited to, a virtual machine (e.g., a virtual machine hosted by a computing device with persistent storage such as NVRAM accessible to the virtual machine for storing a journal), a server, a node, a cluster of nodes, etc.

The techniques introduced here can be embodied as special-purpose hardware (e.g., circuitry), as programmable circuitry appropriately programmed with software and/or firmware, or as a combination of special-purpose and programmable circuitry. Hence, embodiments may include a computer-readable medium or machine readable-medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to various embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

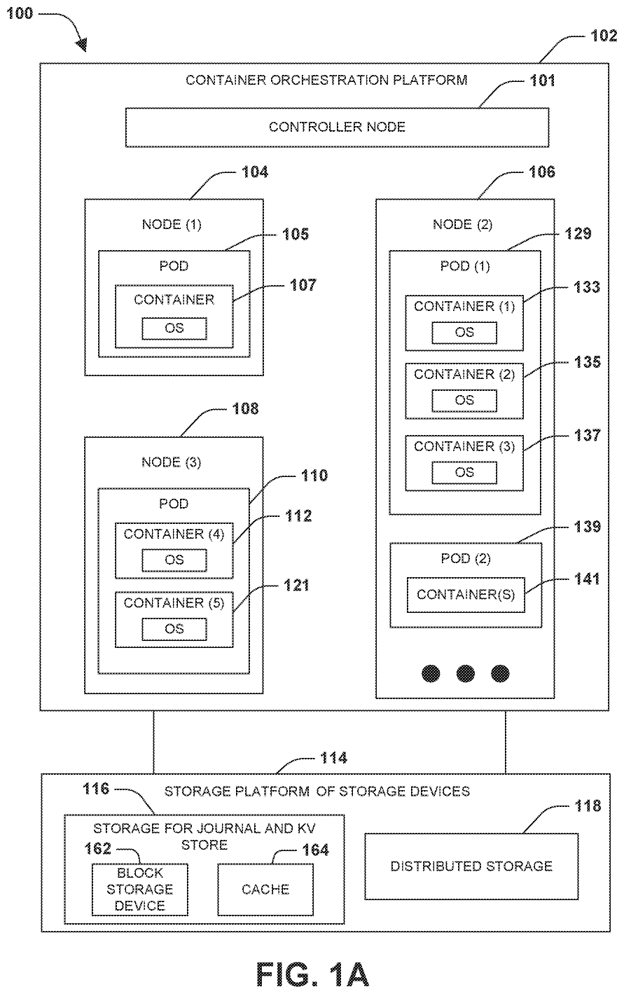

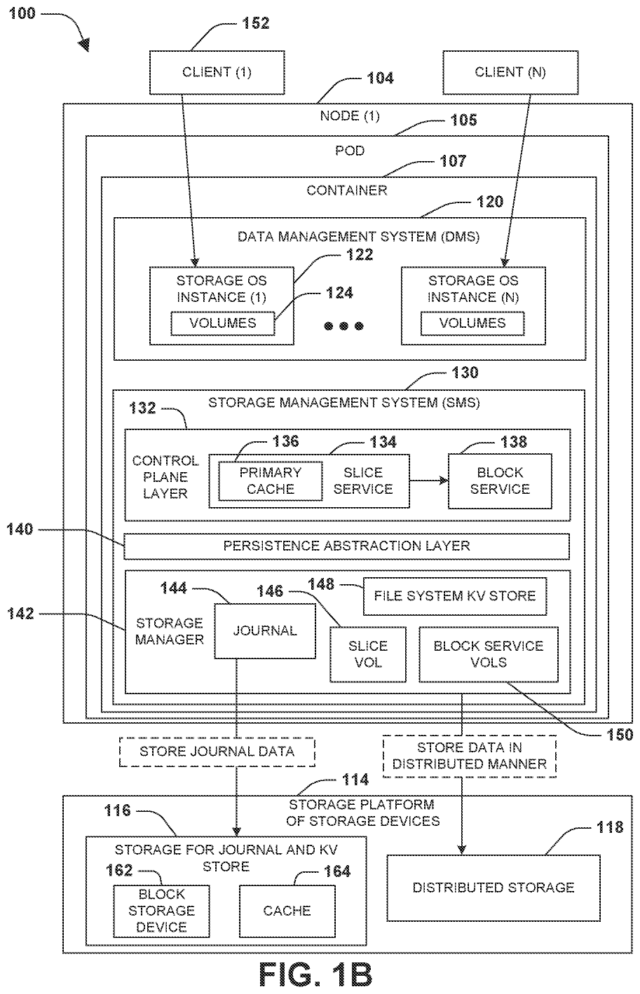

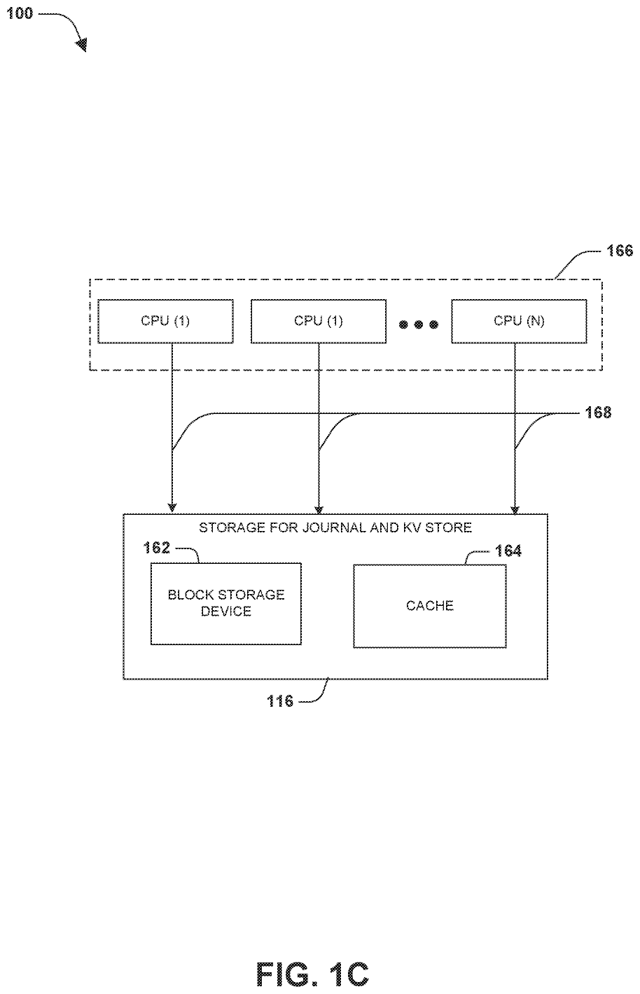

FIG. 1A is a block diagram illustrating an example of various components of a composable, service-based distributed storage architecture 100. In some embodiments, the distributed storage architecture 100 may be implemented through a container orchestration platform 102 or other containerized environment, as illustrated by FIG. 1A. A container orchestration platform can automate storage application deployment, scaling, and management. One example of a container orchestration platform is Kubernetes. Core components of the container orchestration platform 102 may be deployed on one or more controller nodes, such as controller node 101.

The controller node 101 may be responsible for managing the overall distributed storage architecture 100, and may run various components of the container orchestration platform 102 such as an Application Programming Interface (API) server that implements the overall control logic, a scheduler for scheduling execution of containers on nodes, a storage server where the container orchestration platform 102 stores its data. The distributed storage architecture 100 may comprise a distributed cluster of nodes, such as worker nodes that host and manage containers, and also receive and execute orders from the controller node 101. As illustrated in FIG. 1A, for example, the distributed cluster of nodes (e.g., worker nodes) may comprise a first node 104, a second node 106, a third node 108, and/or any other number of other worker nodes.

Each node within the distributed storage architecture 100 may be implemented as a virtual machine, physical hardware, or other software/logical construct. In some embodiments, a node may be part of a Kubernetes cluster used to run containerized applications within containers and handling networking between the containerized applications across the Kubernetes cluster or from outside the Kubernetes cluster. Implementing a node as a virtual machine or other software/logical construct provides the ability to easily create more nodes or deconstruct nodes on-demand in order to scale up or down based upon current demand.

The nodes of the distributed cluster of nodes may host pods that are used to run and manage containers from the perspective of the container orchestration platform 102. A pod may be a smallest deployable unit of computing resources that can be created and managed by the container orchestration platform 102 such as Kubernetes. The pod may support multiple containers and forms a cohesive unit of service for the applications hosted within the containers. That is, the pod provides shared storage, shared network resources, and a specification for how to run the containers grouped within the pod. In some embodiments, the pod may encapsulate an application composed of multiple co-located containers that share resources. These co-located containers form a single cohesive unit of service provided by the pod, such as where one container provides clients with access to files stored in a shared volume and another container updates the files on the shared volume. The pod wraps these containers, storage resources, and network resources together as single unit that is managed by the container orchestration platform 102.

In some embodiments, a storage application within a first container may access a deduplication application within a second container and a compression application within a third container in order to deduplicate and/or compress data managed by the storage application. Because these applications cooperate together, a single pod may be used to manage the containers hosting these applications. These containers that are part of the pod may be co-located and scheduled on a same node, such as the same physical hardware or virtual machine. This allows the containers to share resources and dependencies, communicate with one another, and/or coordinate their lifecycles of how and when the containers are terminated.

A node may host multiple containers, and one or more pods may be used to manage these containers. For example, a pod 105 within the first node 104 may manage a container 107 and/or other containers hosting applications that may interact with one another. A pod 129 within the second node 106 may manage a first container 133, a second container 135, and a third container 137 hosting applications that may interact with one another. A pod 139 of the second node 106 may manage one or more containers 141 hosting applications that may interact with one another. A pod 110 within the third node 108 may manage a fourth container 112 and a fifth container 121 hosting applications that may interact with one another.

The fourth container 112 may be used to execute applications (e.g., a Kubernetes application, a client application, etc.) and/or services such as storage management services that provide clients with access to storage hosted or managed by the container orchestration platform 102. In some embodiments, an application executing within the fourth container 112 of the third node 108 may provide clients with access to storage of a storage platform 114. For example, a file system service may be hosted through the fourth container 112. The file system service may be accessed by clients in order to store and retrieve data within storage of the storage platform 114. For example, the file system service may be an abstraction for a volume, which provides the clients with a mount point for accessing data stored through the file system service in the volume.

In some embodiments, the distributed cluster of nodes may store data within distributed storage 118. The distributed storage 118 may correspond to storage devices that may be located at various nodes of the distributed cluster of nodes. Due to the distributed nature of the distributed storage 118, data of a volume may be located across multiple storage devices that may be located at (e.g., physically attached to or managed by) different nodes of the distributed cluster of nodes. A particular node may be a current owner of the volume. However, ownership of the volume may be seamlessly transferred amongst different nodes. This allows applications, such as the file system service, to be easily migrated amongst containers and/or nodes such as for load balancing, failover, and/or other purposes.

In order to improve I/O latency and client performance, a primary cache may be implemented for each node. The primary cache may be implemented utilizing relatively faster storage, such as non-volatile random access memory (NVRAM), a solid-state drive (SSD), a high endurance SSD, a non-volatile memory Express (NVMe) SSD, an Optane SSD, flash, 3D Xpoint, non-volatile dual in-line memory module (NVDIMM), etc. For example, the third node 108 may implement a primary cache 136 using a journal (and/or a persistent key-value store) that is stored within a storage device 116. In some embodiments, the storage device 116 may store the journal used as the primary cache and/or may also store a persistent key-value store (e.g., the persistent key-value store may also be used as the primary cache). The journal may correspond to a non-volatile log (NVlog). The journal may be used to log input/output (I/O) operations of clients. In some embodiments, the I/O operations comprise modify operations, write operations, metadata operations, configure operations, hole punching operations, cloning operations, and/or one or more other types of I/O operations. The I/O operations may comprise a write operation, wherein the write operation may be logged in the journal before the write operation is stored into other storage such as storage hosting a volume managed by a storage operating system (e.g., the write operation may be logged in the journal by storing a set of journal data, indicative of the write operation, in the journal).

For example, an I/O operation (e.g., a modify operation, a write operation, a metadata operation, a configure operation, a hole punching operation, a cloning operation, and/or other type of I/O operation) may be received from a client application. The I/O operation may be logged into the journal (e.g., the I/O operation may be quickly logged into the journal because the journal is stored within the storage device 116, such as comprising relatively fast storage). A response may be provided back (e.g., quickly provided back) to the client application (e.g., the response may be provided to the client application in response to receiving the I/O operation and/or logging the I/O operation into the journal). In a scenario in which the I/O operation is a write operation, the response may be provided to the client application without having to write data of the write operation to a final destination in the distributed storage 118. In this way, as I/O operations are received, the I/O operations are logged within the journal. So that the journal does not become full and run out of storage space for logging I/O operations, a consistency point may be triggered in order to replay logged I/O operations and/or remove the logged I/O operations from the journal to free up storage space for logging I/O operations.

When the journal becomes full, reaches a certain fullness, or a certain amount of time has passed since a last consistency point was performed, the consistency point is triggered so that the journal does not run out of storage space for logging I/O operations. Once the consistency point is triggered, logged I/O operations are replayed from the journal. In a scenario in which the logged I/O operations comprise logged write operations, the logged I/O operations may be replayed to write data of the logged write operations to the distributed storage 118. Without the use of the journal, a write operation received from a client application would be executed and data of the write operation would be distributed across the distributed storage 118. This would take longer than logging the write operation in the journal because the distributed storage 118 may be comprised of relatively slower storage and/or the data may be stored across storage devices attached to other nodes. Thus, without the journal, latency experienced by the client application is increased because a response for the write operation to the client will take longer. In contrast to the journal where write operations are logged for subsequent replay, read and write operations may be executed using the primary cache 136 (shown in FIG. 1B).

FIG. 1B is a block diagram illustrating an example of an architecture of a worker node, such as the first node 104 hosting the container 107 managed by the pod 105. The container 107 may execute an application, such as a storage application that provides clients with access to data stored within the distributed storage 118. That is, the storage application may provide the clients with read and write access to their data stored within the distributed storage 118 by the storage application. The storage application may be composed of a data management system 120 and a storage management system 130 executing within the container 107.

The data management system 120 is a frontend component of the storage application through which clients can access and interface with the storage application. For example, a plurality of clients (e.g., a first client 152 and/or one or more other clients) may transmit I/O operations to a storage operation system instance 122 hosted by the data management system 120 of the storage application. The data management system 120 routes these I/O operations to the storage management system 130 of the storage application.

The storage management system 130 manages the actual storage of data within storage devices of the storage platform 114, such as managing and tracking where the data is physically stored in particular storage devices. The storage management system 130 may also manage the caching of such data before the data is stored to the storage devices of the storage platform 114. A journal 144 may be hosted as a primary cache 136 for the node. A plurality of I/O operations of the plurality of clients, such as I/O operations received from one or more clients of the plurality of clients, may be logged within the journal 144. A storage device 116 is configured to store the journal 144 as the primary cache 136. Alternatively and/or additionally, the storage device 116 may be configured to store a persistent key-value store.

Because the storage application, such as the data management system 120 and the storage management system 130 of the storage application, are hosted within the container 107, multiple instances of the storage application may be created and hosted within multiple containers. That is, multiple containers may be deployed to host instances of the storage application that may each service I/O requests from clients. The I/O may be load balanced across the instances of the storage application within the different containers. This provides the ability to scale the storage application to meet demand by creating any number of containers to host instances of the storage application. Each container hosting an instance of the storage application may host a corresponding data management system and storage management system of the storage application. These containers may be hosted on the first node 104 and/or at other nodes.

For example, the data management system 120 may host one or more storage operating system instances, such as the first storage operating system instance 122 accessible to the first client 152 for storage data. In some embodiments, the first storage operating system instance 122 may run on an operating system (e.g., Linux) as a process and may support various protocols, such as Network File System (NFS), Common Internet File System (CIFS), and/or other file protocols through which clients may access files through the first storage operating system instance 122. The first storage operating system instance 122 may provide an API layer through which clients, such as the first client 152, may set configurations (e.g., a snapshot policy, an export policy, etc.), settings (e.g., specifying a size or name for a volume), and transmit I/O operations directed to volumes 124 (e.g., FlexVols) exported to the clients by the first storage operating system instance 122. In this way, the clients communicate with the first storage operating system instance 122 through this API layer. The data management system 120 may be specific to the first node 104 (e.g., as opposed to a storage management system (SMS) 130 that may be a distributed component amongst nodes of the distributed cluster of nodes). In some embodiments, the data management system 120 and/or the storage management system 130 may be hosted within a container 107 managed by a pod 105 on the first node 104.

The first storage operating system instance 122 may comprise an operating system stack that includes at least one of a protocol layer (e.g., a layer implementing NFS, CIFS, etc.), a file system layer, a storage layer (e.g., a redundant array of inexpensive/independent disks (RAID) layer), etc. The first storage operating system instance 122 may provide various techniques for communicating with storage, such as through ZAPI commands, representational state transfer (REST) API operations, etc. The first storage operating system instance 122 may be configured to communicate with the storage management system 130 through Internet Small Computer System Interface (iSCSI), remote procedure calls (RPCs), etc. For example, the first storage operating system instance 122 may communicate with virtual disks provided by the storage management system 130 to the data management system 120, such as through iSCSI and/or RPC.

The storage management system 130 may be implemented by the first node 104 as a storage backend. The storage management system 130 may be implemented as a distributed component with instances that are hosted on each of the nodes of the distributed cluster of nodes. The storage management system 130 may host a control plane layer 132. The control plane layer 132 may host a full operating system with a frontend and a backend storage system. The control plane layer 132 may form a control plane that includes control plane services, such as a slice service 134 that manages slice files used as indirection layers for accessing data on disk, a block service 138 that manages block storage of the data on disk, a transport service used to transport commands through a persistence abstraction layer 140 to a storage manager 142, and/or other control plane services. The slice service 134 may be implemented as a metadata control plane and the block service 138 may be implemented as a data control plane. Because the storage management system 130 may be implemented as a distributed component, the slice service 134 and the block service 138 may communicate with one another on the first node 104 and/or may communicate (e.g., through remote procedure calls) with other instances of the slice service 134 and the block service 138 hosted at other nodes within the distributed cluster of nodes.

In some embodiments of the slice service 134, the slice service 134 may utilize slices, such as slice files, as indirection layers. The first node 104 may provide the first client 152 with access to a logical unit number (LUN) or volume through the data management system 120. The LUN may have N logical blocks that may be 1 kb each. If one of the logical blocks is in use and storing data, then the logical block has a block identifier of a block storing the actual data. A slice file for the LUN (or volume) has mappings that map logical block numbers of the LUN (or volume) to block identifiers of the blocks storing the actual data. Each LUN or volume will have a slice file, so there may be hundreds of slices files that may be distributed amongst the nodes of the distributed cluster of nodes. A slice file may be replicated so that there is a primary slice file and one or more secondary slice files that are maintained as copies of the primary slice file. When write operations and delete operations are executed, corresponding mappings that are affected by these operations are updated within the primary slice file. The updates to the primary slice file are replicated to the one or more secondary slice files. After, the write or deletion operations are responded back to a client as successful. Also, read operations may be served from the primary slice since the primary slice may be the authoritative source of logical block to block identifier mappings.

In some embodiments, the control plane layer 132 may not directly communicate with the storage platform 114, but may instead communicate through the persistence abstraction layer 140 to a storage manager 142 that manages the storage platform 114. In some embodiments, the storage manager 142 may comprise storage operating system functionality running on an operating system (e.g., Linux). The storage operating system functionality of the storage manager 142 may run directly from internal APIs (e.g., as opposed to protocol access) received through the persistence abstraction layer 140. In some embodiments, the control plane layer 132 may transmit I/O operations through the persistence abstraction layer 140 to the storage manager 142 using the internal APIs. For example, the slice service 134 may transmit I/O operations through the persistence abstraction layer 140 to a slice volume 146 hosted by the storage manager 142 for the slice service 134. In this way, slice files and/or metadata may be stored within the slice volume 146 exposed to the slice service 134 by the storage manager 142.

The storage manager 142 may expose a file system key-value store 148 to the block service 138. In this way, the block service 138 may access block service volumes 150 through the file system key-value store 148 in order to store and retrieve key-value store metadata and/or data. The storage manager 142 may be configured to directly communicate with one or more storage devices of the storage platform 114 such as the distributed storage 118 and/or the storage device 116 used to host a journal 144 managed by the storage manager 142 for use as a primary cache 136 by the slice service 134 of the control plane layer 132.

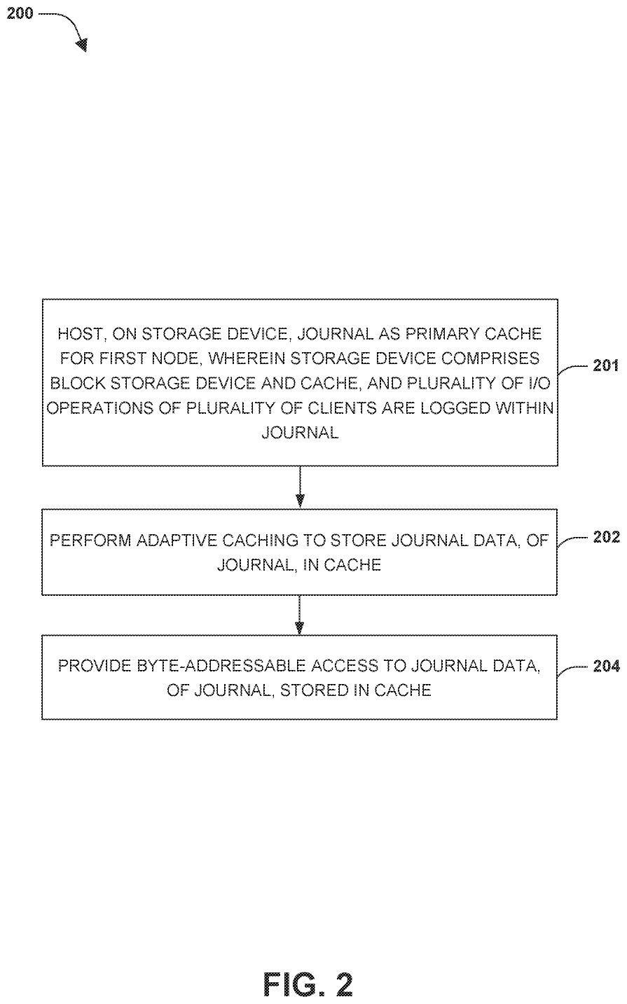

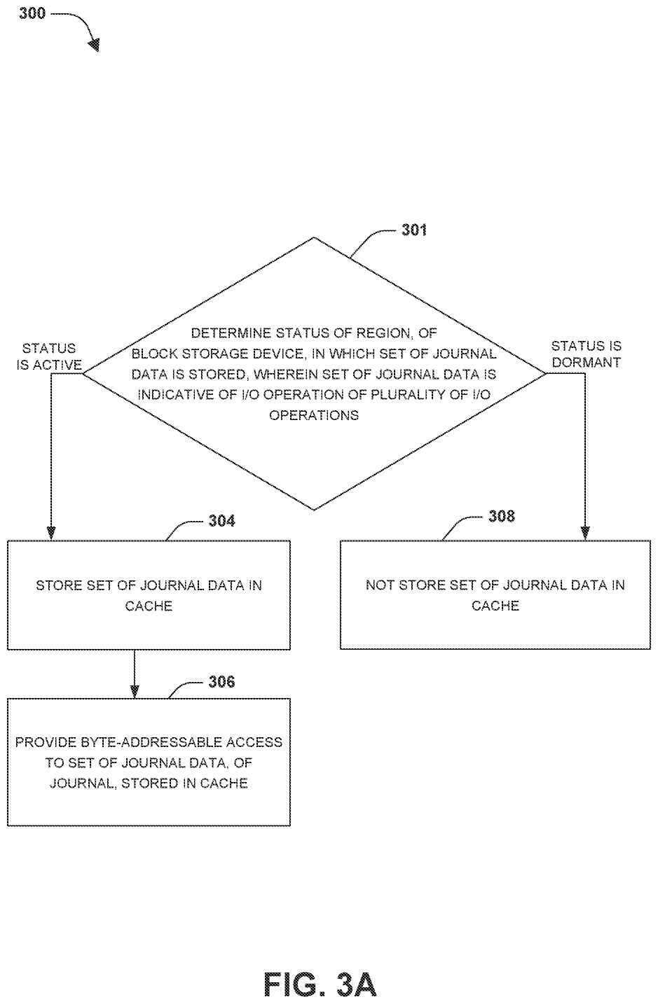

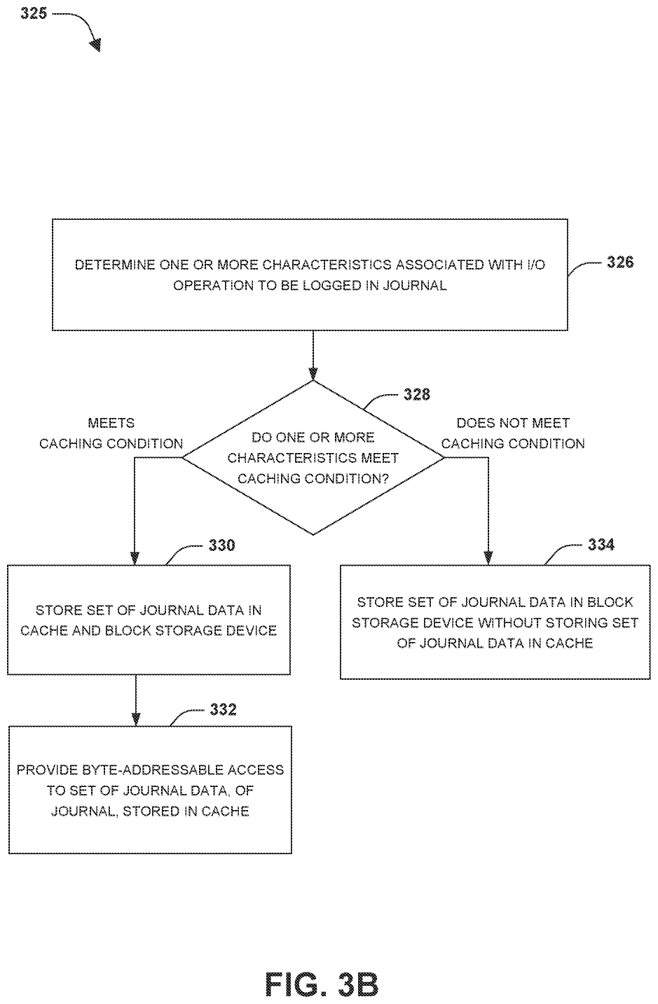

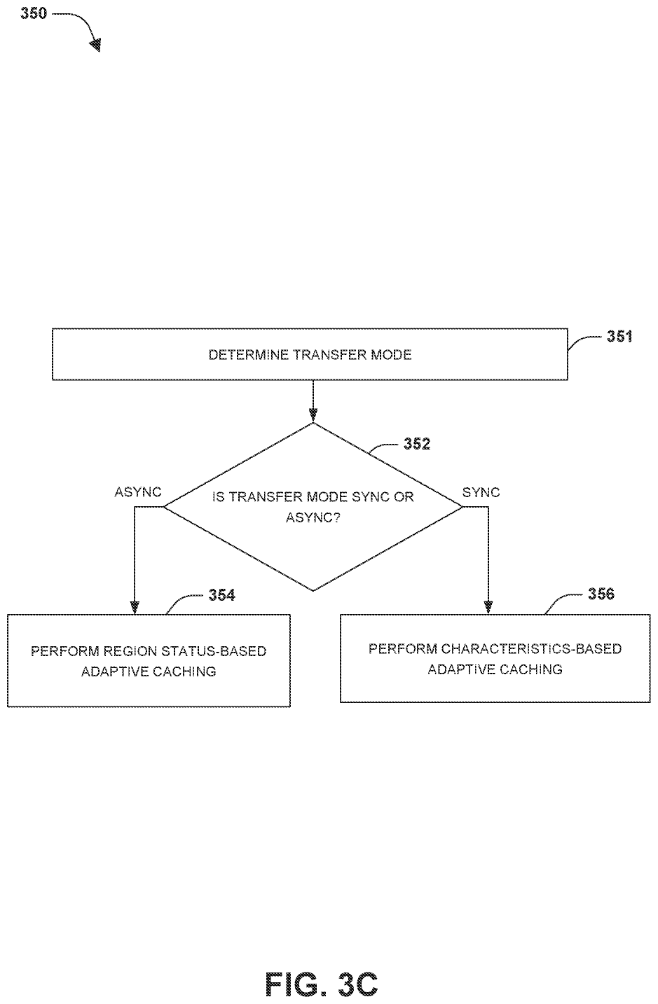

The storage device 116 may comprise a block storage device 162 and a cache 164, as illustrated by FIGS. 1A-1C. In some embodiments, the block storage device 162 is a persistent memory device for persistent storage. In some embodiments, the block storage device 162 comprises at least one of NVRAM, a SSD, a high endurance SSD, a NVMe SSD, an Optane SSD, flash, 3D Xpoint, NVDIMM, etc. The cache 164 may correspond to backing memory of the block storage device 162. The cache 164 may be used to provide byte-addressable access to journal data, of the journal 144, stored on the cache 164. In some embodiments, adaptive caching may be performed to store journal data, of the journal 144, in the cache 164. For example, journal data may be cached in the cache 164 in an adaptive manner (e.g., adaptive to at least one of characteristics associated with journal data, statuses of regions of the block storage device 162 in which journal data is stored, etc.). The adaptive caching may be performed using one or more of the techniques provided herein, such as one or more of the techniques provided with respect to FIGS. 2-3C. As a result of using one or more of the techniques herein to implement adaptive caching for caching journal data in the cache 164, the amount of backing memory (e.g., memory of the cache 164) used for caching journal data of the journal 144 may be reduced by a significant amount (e.g., about 90% in some cases).

In some embodiments, journal data (e.g., journal data determined to be stored in the cache 164) may be stored in the cache 164, then offloaded to the block storage device 162. In some embodiments, a persisting process in which journal data (that is stored on the cache 164, for example) is stored the block storage device 162 may be performed periodically (e.g., the persisting process may comprise offloading and/or persisting journal data in the cache 164 to the block storage device 162). In some embodiments, the persisting process may be performed periodically when a sync transfer mode is implemented for transferring sets of data to the journal 144 and/or the persistent key-value store. In some embodiments, the persisting process may be performed such that journal data to be stored in the block storage device 162 is block aligned data (e.g., the block aligned data may comprise one or more blocks of data according to a fixed block size of the block storage device 162).

In some embodiments, byte-addressability is abstracted from a client associated with the journal 144 by choosing first journal data (e.g., journal data that meets a condition and/or is considered to be active data) to be stored in the cache 164 and choosing second journal data (e.g., journal data that does not meet a condition and/or is considered to be dormant data, such as inactive data) to not be stored in the cache 164. For example, the first journal data (to be stored in the cache 164) and/or the second journal data (not to be stored in the cache 164) may be selected based upon at least one of one or more characteristics associated with the data (such as discussed with respect to FIG. 3B), one or more statuses of one or more regions in which the data is stored (such as discussed with respect to FIG. 3A), etc. Byte-addressable access to journal data may be provided through the abstraction.

In some embodiments, journal data may be transferred from the block storage device 162 to the cache 164 in order to perform a read operation on the journal data. For example, after transferring the journal data from the block storage device 162 to the cache 164, the journal data may be read in a byte-addressable manner.

FIG. 1C is a block diagram illustrating an example of a plurality of paths 168 implemented by the distributed storage architecture 100. A plurality of central processing units (CPUs) 166 (and/or a plurality of CPU thread contexts) can concurrently issue data transfers, through the plurality of paths 168, to store journal data in the storage device 116. The plurality of CPUs 166 may comprise N CPUs (e.g., CPUs (1)-(N)) (and/or the plurality of CPU thread contexts may comprise N CPU thread contexts). In some embodiments, the plurality of CPUs 166 (and/or the plurality of CPU thread contexts) may concurrently issue data transfers to a plurality of caches (e.g., N caches). In some embodiments, a first CPU of the plurality of CPUs 166 may perform a first write operation to the storage device 116 via a first path of the plurality of paths 168, where a second CPU of the plurality of CPUs 166 may be allowed to concurrently perform a second write operation to the storage device 116 via a second path of the plurality of paths 168. In some embodiments, the plurality of paths 168 are a plurality of flushing threads used to facilitate concurrent data transfers from clients to the journal 144 (and/or to the persistent key-value store). In some embodiments, the plurality of paths 168 are implemented by the data management system 120 (and/or the storage management system 130).

It may be appreciated that the container orchestration platform 102 of FIGS. 1A-1C are merely one example of a computing environment within which the techniques described herein may be implemented, and that the techniques described herein may be implemented in other types of computing environments (e.g., a cluster computing environment of nodes such as virtual machines or physical hardware, a non-containerized environment, a cloud computing environment, a hyperscaler, etc.).

FIG. 2 is a flow chart illustrating an example set of operations of an example method 200 that implement a journal for a plurality of clients using a block storage device. The example method 200 is further described in conjunction with distributed storage architecture 100 of FIGS. 1A-1C. During operation 201, the journal 144 is hosted, on the storage device 116, as the primary cache 136 for the first node 104 of the distributed cluster of nodes hosted within the container orchestration platform 102. The first node 104 may be configured to store data across distributed storage 118 managed by nodes of the distributed cluster of nodes, such as at least one of the first node 104, the second node 106, the third node 108, etc. A plurality of I/O operations of a plurality of clients (e.g., the plurality of I/O operations may comprise I/O operations received from clients of the plurality of clients) may be logged within the journal 144.

During operation 202, adaptive caching may be performed to store journal data, of the journal 144, in the cache 164. For example, journal data may be cached in the cache 164 in an adaptive manner (e.g., adaptive to at least one of characteristics associated with journal data, statuses of regions of the block storage device 162 in which journal data is stored, etc.). In some embodiments, an entirety of journal data of the journal 144 may be stored on the block storage device 162 and at least some journal data, of the journal 144, is stored on the cache 164. In some embodiments, merely a portion of journal data of the journal 144 may be stored in the cache 164 at any given point in time. The cache 164 may be used to provide byte-addressable access to journal data, of the journal 144, stored on the cache 164. Byte-addressable access to journal data stored on the cache 164 may be provided to one or more clients of the plurality of clients. Accordingly, a set of journal data of the journal 144 may be stored in the cache 164 to provide byte-addressable access to the set of journal data.

In some examples, whether or not to store a set of journal data in the cache 164 (in order to provide byte-addressable access to the set of journal data, for example) may be determined based upon one or more characteristics associated with the set of journal data (e.g., one or more characteristics associated with an I/O operation corresponding to the set of journal data), such as using one or more of the techniques provided herein with respect to FIG. 3B. In some embodiments, the one or more characteristics may comprise a type of I/O operation of the I/O operation, a size of the set of journal data indicative of the I/O operation, and/or a client, of the plurality of clients, associated with the I/O operation (e.g., a client from which the I/O operation is received). In some embodiments, characteristics-based adaptive caching (e.g., adaptive caching that is performed based upon characteristics associated with I/O operations, such as using one or more of the techniques provided herein with respect to FIG. 3B) may be performed using the one or more characteristics if a sync transfer mode is implemented for transferring sets of data to the journal 144 and/or the persistent key-value store. For example, the one or more characteristics may be used to determine whether or not to store the set of journal data in the cache 164 based upon a determination that the sync transfer mode is implemented.

Alternatively and/or additionally, whether or not to store a set of journal data in the cache 164 (in order to provide byte-addressable access to the set of journal data, for example) may be determined based upon a status of a region, of the block storage device 162, in which the set of journal data is stored, such as using one or more of the techniques provided herein with respect to FIG. 3A. In some embodiments, the status of the region may be active or dormant. In some embodiments, region status-based adaptive caching (e.g., adaptive caching that is performed based upon the status of the region in which the set of journal data is stored, such as using one or more of the techniques provided herein with respect to FIG. 3A) may be performed using the status of the region if an async transfer mode is implemented for transferring sets of data to the journal 144 and/or the persistent key-value store. For example, the status of the region may be used to determine whether or not to store the set of journal data in the cache 164 based upon a determination that the async transfer mode is implemented. In some embodiments, the set of journal data may be stored in the cache 164 based upon a determination that the status of the region is active. Alternatively and/or additionally, the set of journal data may not be stored in the cache 164 based upon a determination that the status of the region is dormant.

During operation 204, byte-addressable access to journal data, of the journal, stored in the cache may be provided. In some embodiments, the cache 164 may have a byte-addressable memory architecture, wherein individual bytes of data stored in the cache 164 can be accessed and/or addressed. Non-block aligned data (e.g., data that is not aligned with a block size of the block storage device) may be stored in the cache 164. In some embodiments, the byte-addressable access to the journal data may be provided by the storage management system 130. The byte-addressable access to the journal data may be provided to one or more clients of the plurality of clients (e.g., the first client 152 and/or one or more other clients). For example, read and write access to journal data stored in the cache 164 may be provided to one or more clients (of the plurality of clients, for example) through the data management system 120 and the storage management system 130 of the container 107.

In some embodiments, a first I/O operation may be received from the first client 152. The first I/O operation may comprise a modify operation, a write operation, a metadata operation, a configure operation, a hole punching operation, a cloning operation, and/or other type of I/O operation. In response to receiving the first I/O operation, the first I/O operation may be logged into the journal 144 and/or a response may be transmitted to the first client 152 (e.g., the response may be indicative of the first I/O operation being logged into the journal 144 and/or may be transmitted to the first client 152 in response to logging the first I/O operation into the journal 144). In some embodiments, logging the first I/O operation into the journal 144 comprises storing a first set of journal data, indicative of the first I/O operation, in the block storage device 162. The block storage device 162 may have a block addressable memory architecture. Storing the first set of journal data in the block storage device 162 may comprise storing block aligned data in the block storage device 162, wherein the block aligned data comprises the first set of journal data and/or is generated based upon the first set of journal data. For example, the block aligned data may comprise one or more blocks of data according to a fixed block size of the block storage device 162, such as 4 kilobyte blocks or a different block size. In some embodiments, the one or more blocks of data may comprise a payload and padding. For example, the padding may be included in the block aligned data such that the one or more blocks match the fixed block size of the block storage device 162.

In some embodiments, whether or not to store the first set of journal data in the cache 164 may be determined before, after, or concurrently with storing the first set of journal data in the block storage device 162. For example, the storage management system 130 may implement an adaptive caching system configured to manage storage of journal data in the cache 164, wherein the adaptive caching system determines whether or not to store the first set of journal data in the cache 164.

In some embodiments, whether or not to store the first set of journal data in the cache 164 is determined before the first set of journal data is stored in the block storage device 162. For example, in response to a determination to store the first set of journal data in the cache 164, the first set of journal data may be stored in the cache 164, and after storing the first set of journal data in the cache 164 (e.g., in response to storing the first set of journal data in the cache 164), the first set of journal data may be stored in the block storage device 162 (e.g., the first set of journal data may be transferred and/or offloaded from the cache 164 to the block storage device 162).

In some embodiments, in response to determining (by the adaptive caching system, for example) to store the first set of journal data in the cache 164, the first set of journal data may be stored in the cache 164. Storing the first set of journal data in the block storage device 162 may comprise storing non-block aligned data in the block storage device 162, wherein the non-block aligned data comprises the first set of journal data and/or is generated based upon the first set of journal data.

In some embodiments, in response to determining (by the adaptive caching system, for example) not to store the first set of journal data in the cache 164, the first set of journal data may not be stored in the cache 164. For example, the first set of journal data may be stored in the block storage device 162 without storing the first set of journal data in the cache 164.

In some embodiments, the first set of journal data may comprise time information associated with the first I/O operation (e.g., a time at which the first I/O operation is received from the first client 152), data associated with the first I/O operation (e.g., data received from the first client 152), metadata associated with the first I/O operation (e.g., metadata received from the first client 152), an indication of the first I/O operation (e.g., an indication that the first I/O operation is a write operation, a metadata operation, a configure operation, a hole punching operation, a cloning operation, and/or other type of I/O operation), etc. In some embodiments, the first set of journal data may comprise a key-value record pair. For example, the data (associated with the first I/O operation) of the first set of journal data may comprise a value of the key-value record pair. The value may be from the first I/O operation of the first client 152. Alternatively and/or additionally, the metadata (associated with the first I/O operation) of the first set of journal data may comprise a key of the key-value record pair. Alternatively and/or additionally, the metadata may comprise data (e.g., data internal to the journal 144) that is representative of one or more objects used by the journal 144 for maintaining data, managing data and/or ordering data. In a scenario in which the first I/O operation is a write operation for writing data to storage, the first set of journal data may comprise the data to be written to storage.

FIG. 3A is a flow chart illustrating an example set of operations of an example method 300 for implementing region status-based adaptive caching for storing journal data, of a journal, in a cache. The example method 300 is further described in conjunction with distributed storage architecture 100 of FIGS. 1A-1C. During operation 301, a first status of a first region of the block storage device 162 may be determined (using the adaptive caching system of the storage management system 130, for example). The first region is a region in which the first set of journal data is stored. The first status of the first region may be determined to be active or dormant (e.g., inactive).

In some embodiments, the first region (of the block storage device 162) is selected for storage of the first set of journal data based upon a client (e.g., the first client 152) associated with the first set of journal data and/or the first I/O operation and/or based upon a type of client of the client associated with the first set of journal data and/or the first I/O operation. For example, the first set of journal data may be stored in the first region in response to the selection of the first region for storage of the first set of journal data (e.g., the first region may be selected for storage of the first set of journal data prior to storing the first set of journal data in the block storage device 162). In some embodiments, the block storage device 162 may comprise a plurality of regions (e.g., memory regions) comprising the first region and other regions. For example, the plurality of regions may correspond to a plurality of slabs of the block storage device 162 (e.g., a region of the plurality of regions may correspond to a logical representation of one or more slabs of the block storage device 162). In some embodiments, the plurality of slabs may comprise slabs of varying sizes (and/or the plurality of regions may comprise regions of varying sizes). In some embodiments, one or more slabs of the first region in which the first set of journal data is stored may be selected (prior to storing the first set of journal data in the one or more slabs of the first region, for example) based upon an allocation size associated with the client (and/or an allocation size associated with the first set of journal data) and/or based upon the type of client of the client.

In some embodiments, the first status may be active when data (e.g., the first set of journal data) stored in the first region is to be accessed and/or used by a client of the plurality of clients. In some embodiments, the first status may be dormant when data (e.g., the first set of journal data) stored in the first region is not to be accessed and/or used by a client of the plurality of clients. Whether the first status is active or dormant may be determined based upon one or more data transfers between one or more clients of the plurality of clients and the journal. Alternatively and/or additionally, whether the first status is active or dormant may be determined based upon whether or not the first region is in use, such as whether or not an operation (e.g., at least one of a read operation, a write operation, etc.) is being performed on the first region of the block storage device 162. For example, activity over some and/or all regions of the block storage device 162 may be monitored (e.g., monitored continuously, periodically and/or irregularly) to update (e.g., keep track of) statuses of the regions. A status of a region of the block storage device may be changed (e.g., updated) from dormant to active (while monitoring the region, for example) based upon detecting an operation (e.g., at least one of a read operation, a write operation, etc.) performed on the region. Alternatively and/or additionally, a status of a region of the block storage device may be changed (e.g., updated) from active to dormant (while monitoring the region, for example) based upon a determination that an operation (e.g., at least one of a read operation, a write operation, etc.) has not been performed on the region (e.g., no activity on the region has been detected for a threshold duration of time).

In some embodiments, journal data, of the journal 144, that is stored in an active region of the block storage device 162 (e.g., a region having a status that is active), may also be stored in the cache 164. Alternatively and/or additionally, journal data, of the journal 144, that is stored in a dormant region (e.g., a region having a status that is dormant) of the block storage device 162, may not be stored in the cache 164. Alternatively and/or additionally, after storing journal data of the journal 144 in the cache 164, in response to a determination that a region of the block storage device 164 in which the journal data is stored is dormant (e.g., the status of the region changed from active to dormant), the journal data may be removed from the cache 164 (in order to free up memory on the cache 164, for example). In a first example scenario, a set of journal data may be stored in a region of the block storage device 162. In response to a determination that a status of the region (in which the set of journal data is stored) is dormant, the set of journal data may not be stored in the cache 164 (e.g., while the status of the region is dormant, the set of journal data is only stored on the block storage device 162 without being stored in the cache 164). In response to a determination that the status of the region changes from dormant to active, the set of journal data may be stored in the cache 164 (e.g., while the status of the region is active, the set of journal data is stored on the block storage device 162 and the cache 164). In response to a determination that the status of the region changes from active to dormant, the set of journal data may be removed from the cache 164 (in order to free up memory on the cache 164, for example).

If the first status of the first region of the block storage device 162 is active, the first set of journal data may be stored in the cache 164, during operation 304. For example, the first set of journal data may be stored in the cache 164 in response to a determination that the first status of the first region of the block storage device 162 is active. Byte-addressable access to the first set of journal data stored in the cache 164 may be provided, during operation 306. In some embodiments, the byte-addressable access to the first set of journal data may be provided by the storage management system 130. The byte-addressable access to the first set of journal data may be provided to one or more clients of the plurality of clients (e.g., the first client 152 and/or one or more other clients). For example, when the first set of journal data is stored in the cache 164, data of the first set of journal data (e.g., the data may comprise some and/or all of the first set of journal data) may be read from the cache 164 and/or provided to a client (e.g., the first client 152). For example, the data may be read from the cache 164 and/or provided to the client in response to receiving a request from the client. In some embodiments, the request comprises one or more addresses of one or more bytes, wherein the data is read from the cache 164 and/or provided to the first client 152 based upon the one or more addresses.

If the first status of the first region of the block storage device 162 is dormant, the first set of journal data may not be stored in the cache 164, during operation 308. Accordingly, when the first status of the first region of the block storage device 162 is dormant, the first set of journal data may be stored in the block storage device 162 and may not be stored in the cache 164. In some embodiments, when journal data (e.g., the first set of journal data) is not stored in the cache 164, byte-addressable access to the journal data may not be provided.

FIG. 3B is a flow chart illustrating an example set of operations of an example method 325 for implementing characteristics-based adaptive caching for storing journal data, of a journal, in a cache. The example method 325 is further described in conjunction with distributed storage architecture 100 of FIGS. 1A-1C. During operation 326, one or more first characteristics associated with the first I/O operation to be logged in the journal 144 may be determined.

In some embodiments, the one or more first characteristics may be determined in response to receiving the first I/O operation. The first I/O operation may be received from the first client 152. In some embodiments, the one or more first characteristics may comprise a type of I/O operation of the first I/O operation, a size of the first set of journal data indicative of the first I/O operation, and/or a client, of the plurality of clients, associated with the first I/O operation (e.g., a client from which the first I/O operation is received, such as the first client 152). The one or more first characteristics may comprise a client identifier of the first client 152 (e.g., a unique identifier for the first client 152).

In some embodiments, whether to store the first set of journal data in both the block storage device 162 and the cache 164 or to store the first set of journal data in merely the block storage device 162 may be determined based upon the one or more first characteristics.

In some embodiments, the first set of journal data may be stored in the block storage device 162 and the cache 164 based upon a determination that the one or more first characteristics meet a caching condition. Alternatively and/or additionally, the first set of journal data may be stored in the cache 164 based upon a determination that the one or more first characteristics do not meet the caching condition.

In some embodiments, the caching condition may comprise a condition that the size of the first set of journal data is smaller than a threshold size. The size of the first set of journal data may correspond to a quantity of memory units, such as bytes, bits, etc. to be occupied by the first set of journal data within the cache 164 if stored in the cache 164, wherein the threshold size may correspond to a threshold quantity of the memory units. For example, it may be determined that the caching condition is met based upon a determination that the size of the first set of journal data is smaller than the threshold size. Alternatively and/or additionally, it may be determined that the caching condition is not met based upon a determination that the size of the first set of journal data is larger than the threshold size.

In some embodiments, the caching condition may comprise a condition that the type of I/O operation of the first I/O operation matches a type of I/O condition of one or more first types of I/O operations. In some embodiments, the one or more first types of I/O operations may comprise at least one of modify operation, write operation, metadata operation, a configure operation, hole punching operation, cloning operation, and/or other type of I/O operation. For example, it may be determined that the caching condition is met based upon a determination that the type of I/O operation of the first I/O operation matches a type of I/O condition of one or more first types of I/O operations (e.g., in a scenario in which the one or more first types of I/O operations comprise write operation, it may be determined that the caching condition is met based upon a determination that the first I/O operation is a write operation). Alternatively and/or additionally, it may be determined that the caching condition is not met based upon a determination that the type of I/O operation of the first I/O operation does not match a type of I/O condition of one or more first types of I/O operations (e.g., in a scenario in which the one or more first types of I/O operations does not comprise cloning operation, it may be determined that the caching condition is not met based upon a determination that the first I/O operation is a cloning operation).

In some embodiments, the caching condition may comprise a condition that the first client 152 associated with the first I/O operation is part of a first group of clients for which journal data (e.g., indicative of I/O operations of the first group of clients) is stored in the cache 164. For example, it may be determined that the caching condition is met based upon a determination that the first client 152 associated with the first I/O operation is part of the first group of clients (e.g., based upon a determination that the client identifier of the first client 152 matches a client identifier of a first plurality of client identifiers associated with the first group of clients). Alternatively and/or additionally, it may be determined that the caching condition is not met based upon a determination that the first client 152 associated with the first I/O operation is not part of the first group of clients (e.g., based upon a determination that the client identifier of the first client 152 does not match a client identifier of the first plurality of client identifiers associated with the first group of clients).

In some embodiments, the caching condition may comprise a condition that the first client 152 associated with the first I/O operation is not part of a second group of clients for which journal data (e.g., indicative of I/O operations of the second group of clients) is not stored in the cache 164 (e.g., journal data associated with the second group of clients is merely stored in the block storage device 162). For example, it may be determined that the caching condition is met based upon a determination that the first client 152 associated with the first I/O operation is not part of the second group of clients (e.g., based upon a determination that the client identifier of the first client 152 does not match a client identifier of a second plurality of client identifiers associated with the second group of clients). Alternatively and/or additionally, it may be determined that the caching condition is not met based upon a determination that the first client 152 associated with the first I/O operation is part of the second group of clients (e.g., based upon a determination that the client identifier of the first client 152 matches a client identifier of the second plurality of client identifiers associated with the second group of clients).

In some embodiments, the first group of clients and/or the second group of clients may be determined based upon historical I/O information associated with the plurality of clients. For example, based upon the historical I/O information, clients may be selected, from the plurality of clients, for inclusion in the first group of clients and/or the second group of clients. In some embodiments, the historical I/O information may comprise at least one of historical I/O operations of clients of the plurality of clients, types of I/O operations of historical I/O operations of clients of the plurality of clients, I/O operation patterns of clients of the plurality of clients, sizes of data transfers between clients of the plurality of clients and the journal 144, etc.

In some embodiments, the historical I/O information may comprise a first set of historical I/O information associated with the first client 152. Whether or not to include the first client 152 in the first group of clients (and/or whether or not to include the first client 152 in the second group of clients) may be determined based upon the first set of historical I/O information associated with the first client 152. The first set of historical I/O information may comprise at least one of historical I/O operations of the first client 152, types of I/O operations of historical I/O operations of the first client 152, one or more I/O operation patterns of historical I/O operations of the first client 152, sizes of historical data transfers between the first client 152 and the journal 144, etc.

In some embodiments, the first client 152 may be included in the first group of clients (and/or may not be included in the second group of clients) based upon a determination that a data transfer size associated with the first client 152 is smaller than a threshold data transfer size. Alternatively and/or additionally, the first client 152 may not be included in the first group of clients (and/or may be included in the second group of clients) based upon a determination that the data transfer size associated with the first client 152 is larger than the threshold data transfer size. In some embodiments, the data transfer size may be determined based upon the sizes of the historical data transfers between the first client 152 and the journal 144. For example, one or more operations (e.g., mathematical operations) may be performed using the sizes of the historical data transfers to determine the data transfer size associated with the first client 152. In some embodiments, the sizes of the historical data transfers may be averaged to determine the data transfer size associated with the first client 152 (e.g., the data transfer size associated with the first client 152 may correspond to an average size of the sizes of the historical data transfers).

In some embodiments, the first client 152 may be included in the first group of clients (and/or may not be included in the second group of clients) based upon a determination that a proportion of historical I/O operations associated with the first client 152 that are byte addressable I/O operations exceeds a threshold proportion. For example, the threshold proportion may correspond to 50%, where the first client 152 may be included in the first group of clients (and/or may not be included in the second group of clients) based upon a determination that at least 50% of historical I/O operations associated with the first client 152 are byte addressable I/O operations (e.g., non-block aligned I/O operations). Alternatively and/or additionally, the first client 152 may not be included in the first group of clients (and/or may be included in the second group of clients) based upon a determination that a proportion of historical I/O operations associated with the first client 152 that are byte addressable I/O operations is below the threshold proportion. For example, the threshold proportion may correspond to 50%, where the first client 152 may not be included in the first group of clients (and/or may be included in the second group of clients) based upon a determination that less than 50% of historical I/O operations associated with the first client 152 are byte addressable I/O operations (e.g., non-block aligned I/O operations).

In some embodiments, whether the one or more first characteristics meet the caching condition is determined, during operation 328. If the one or more first characteristics meet the caching condition, the first set of journal data may be stored in the cache 164 and the block storage device 162, during operation 330. For example, the first set of journal data may be stored in the cache 164 in response to a determination that the one or more first characteristics meet the caching condition. Byte-addressable access to the first set of journal data stored in the cache 164 may be provided, during operation 332. In some embodiments, the byte-addressable access to the first set of journal data may be provided by the storage management system 130. The byte-addressable access to the first set of journal data may be provided to one or more clients of the plurality of clients (e.g., the first client 152 and/or one or more other clients). For example, when the first set of journal data is stored in the cache 164, data of the first set of journal data (e.g., the data may comprise some and/or all of the first set of journal data) may be read from the cache 164 and/or provided to a client (e.g., the first client 152). For example, the data may be read from the cache 164 and/or provided to the client in response to receiving a request from the client. In some embodiments, the request comprises one or more addresses of one or more bytes, wherein the data is read from the cache 164 and/or provided to the first client 152 based upon the one or more addresses.

If the one or more first characteristics do not meet the caching condition, the first set of journal data may be stored in the block storage device 162 without storing the first set of journal data in the cache 164 (e.g., the first set of journal data may not be stored in the cache 164), during operation 334. In some embodiments, when journal data (e.g., the first set of journal data) is not stored in the cache 164, byte-addressable access to the journal data may not be provided.

FIG. 3C is a flow chart illustrating an example set of operations of an example method 350 for implementing adaptive caching for storing journal data, of a journal, in a cache. The example method 350 is further described in conjunction with distributed storage architecture 100 of FIGS. 1A-1C. During operation 351, a transfer mode (e.g., a transfer mode for transferring sets of data, such as journal data, to the journal 144) may be determined. For example, the transfer mode may be a Direct Memory Access (DMA) transfer mode (e.g., a DMA transfer mode for transferring sets of data, such as journal data, to the journal 144).

The storage device 116, allocated and used by the journal 144, may also be used as storage for the persistent key-value store. In some embodiments, the first node 104 (of the distributed cluster of nodes hosted within the container orchestration platform 102) is configured to store data across the distributed storage 118 managed by the distributed cluster of nodes. The data may be cached as key-value record pairs within the persistent key-value store (e.g., within the primary cache) for read and write access until the data is written in a distributed manner across the distributed storage. For example, read and write access to data within the persistent key-value store may be provided to one or more clients (of the plurality of clients, for example) through the data management system 120 and the storage management system 130 of the container 107.

In some embodiments, a sync transfer mode (e.g., a sync DMA transfer mode) may be implemented for transferring a set of journal data to the journal 144 (e.g., storing the set of journal data in the storage device 116, such as the block storage device 162 and/or the cache 164). For example, the set of journal data may be transferred to the journal 144 to log an I/O operation, received from a client, in the journal 144 (e.g., the set of journal data may be indicative of the I/O operation). In some embodiments, the I/O operation may be replied to in-line with the operation being processed. In some embodiments, an async transfer mode (e.g., an async DMA transfer mode) may be implemented for queuing a message to log the operation into the journal 144 for subsequent processing.

The sync transfer mode or the async transfer mode may be selected based upon a latency of a backing storage device (e.g., a storage device for storing the journal 144 and/or the persistent key-value store, such as the storage device 116), such as where the sync transfer mode may be implemented for lower latency backing storage devices (e.g., the storage device 116) and the async transfer mode may be implemented for higher latency backing storage devices (e.g., the storage device 116). In some embodiments, the sync transfer mode may provide high concurrency and lower memory usage in order to provide performance benefits. In some embodiments, the sync transfer mode may be used for both the journal 144 and the persistent key-value store, such as where the backing storage device (e.g., the storage device 116) is a relatively fast persistent storage device. The sync transfer mode may be implemented (for transferring sets of data to the journal 144 and/or the persistent key-value store, for example) in response to a latency of the storage device 116 being below a threshold latency. In some embodiments, the async transfer mode may be used for both journal 144 and the persistent key-value store, such as where a backing storage device (e.g., the storage device 116) is relatively slower media. The async transfer mode may be implemented (for transferring sets of data to the journal 144 and/or the persistent key-value store, for example) in response to a latency of the storage device 116 exceeding the threshold latency.

In some embodiments, when the async transfer mode is implemented for transferring sets of data to the journal 144 and/or the persistent key-value store, the storage management system 130 is configured to perform region status-based adaptive caching for storing journal data, of the journal 144, in the cache 164, such as using one or more of the techniques provided with respect to FIG. 3A. In some embodiments, when the sync transfer mode is implemented for transferring sets of data to the journal 144 and/or the persistent key-value store, the storage management system 130 is configured to perform characteristics-based adaptive caching for storing journal data, of the journal 144, in the cache 164, such as using one or more of the techniques provided with respect to FIG. 3B.

Whether the async transfer mode or the sync transfer mode is implemented for transferring sets of data to the journal 144 and/or the persistent key-value store may be determined, during operation 352. If the async transfer mode is implemented for transferring sets of data to the journal 144 and/or the persistent key-value store (such as based upon the latency of the storage device 116 exceeding the threshold latency), region status-based adaptive caching may be performed for determining whether or not to store journal data (e.g., the first set of journal data) in the cache 164. For example, if the first I/O operation is received from the first client 152 when the async transfer mode is implemented for transferring sets of data to the journal 144 and/or the persistent key-value store, the example set of operations of the example method 300 of FIG. 3A may be performed to determine whether or not to store the first set of journal data (indicative of the first I/O operation, for example) in the cache 164 (e.g., the storage management system 130 is configured to determine the first status and/or use the first status to determine whether or not to store the first set of journal data in the cache 164 when the async transfer mode is implemented for transferring sets of data to the journal 144 and/or the persistent key-value store).

If the sync transfer mode is implemented for transferring sets of data to the journal 144 and/or the persistent key-value store (such as based upon the latency of the storage device 116 being below the threshold latency), characteristics-based adaptive caching may be performed for determining whether or not to store journal data (e.g., the first set of journal data) in the cache 164. For example, if the first I/O operation is received from the first client 152 when the sync transfer mode is implemented for transferring sets of data to the journal 144 and/or the persistent key-value store, the example set of operations of the example method 325 of FIG. 3B may be performed to determine whether or not to store the first set of journal data (indicative of the first I/O operation, for example) in the cache 164 (e.g., the storage management system 130 is configured to determine the one or more first characteristics and/or use the one or more first characteristics to determine whether or not to store the first set of journal data in the cache 164 when the sync transfer mode is implemented for transferring sets of data to the journal 144 and/or the persistent key-value store).

In some embodiments, multiple concurrent data transfers to the journal 144 may be facilitated using a multi-threaded approach for improved performance. The data management system 120 (and/or the storage management system 130) may implement a plurality of flushing threads (e.g., the plurality of paths 168) to facilitate concurrent data transfers from clients of the plurality of clients to the journal 144 (and/or to the persistent key-value store). For example, the plurality of flushing threads may provide for multiple clients, of the plurality of clients, to concurrently write data to the journal 144, such as where two or more of the following data transfers are performed concurrently: 1) the first set of journal data associated with the first client 152 is transferred to the journal 144 via a first flushing thread of the plurality of flushing threads; 2) a second set of journal data associated with a second client of the plurality of clients is transferred to the journal 144 via a second flushing thread of the plurality of flushing threads (e.g., the second set of journal data may be indicative of an I/O operation received from the second client); and/or 3) one or more other sets of journal data associated with one or more other clients of the plurality of clients are transferred to the journal 144 via one or more other flushing threads of the plurality of flushing threads.

Alternatively and/or additionally, the plurality of flushing threads may provide for a multi-threaded client, of the plurality of clients, to concurrently write data to the journal 144. In a scenario in which the first client 152 is a multi-threaded client, two or more of the following data transfers may be performed concurrently: 1) the first set of journal data associated with the first client 152 is transferred to the journal 144 via a first thread of the first client 152 and a first flushing thread of the plurality of flushing threads; 2) a second set of journal data associated with the first client 152 is transferred to the journal 144 via a second thread of the first client 152 and a second flushing thread of the plurality of flushing threads (e.g., the second set of journal data may be indicative of a second I/O operation received from the first client 152); and/or 3) one or more other sets of journal data associated with one or more clients of the plurality of clients are transferred to the journal 144 via one or more other flushing threads of the plurality of flushing threads.

In some embodiments, multiple CPUs, of a plurality of CPUs, that are performing write operations may independently and/or concurrently issue data transfers to persist data (e.g., to transfer journal data to the journal 144, such as store the journal data in the storage device 116), which may be achieved by enabling each CPU thread context of multiple CPU thread contexts of one or more CPUs to perform synchronous write operations to the journal 144 (using the plurality of flushing threads, for example). In some embodiments, data-sets persisted by different CPU threads may be maintained separately (to avoid data ordering issues across CPU threads, for example). In some embodiments, a first CPU of the plurality of CPUs may perform a first write operation to the storage device 116, where a second CPU of the plurality of CPUs may be allowed to concurrently perform a second write operation to the storage device 116. In some embodiments, each CPU of the plurality of CPUs is allowed to perform flushing to the storage device 116 in an inline manner (e.g., perform inline writes to the journal 144), thereby avoiding asynchronous flushing, context switching and/or polling delays for the CPU to be able to transfer data to the journal 144.

Some systems may employ data transfer coalescing and/or asynchronous single threaded flushing, such as by coalescing writes and flushing the writes to storage using a single flushing thread that is invoked intermittently. However, the data transfer coalescing, and/or the asynchronous single threaded flushing may cause the systems to have large delays and scheduling costs in polling for write completions, which may limit performance gains achievable from low latency, high bandwidth persistent media, such as at least one of SSD, NVDIMM, etc. Compared to such systems, using the techniques provided herein (e.g., providing the plurality of flushing threads, facilitating concurrent data transfers from clients to the journal using the plurality of flushing threads, and/or enabling CPU thread contexts to perform synchronous write operations to the journal 144) may provide for the following technical effects, advantages, and/or improvements: 1) reduced batching (and/or no batching); 2) reduced asynchronous flushing (and/or no asynchronous flushing); 3) reduced polling delays (and/or no polling delays); and/or 4) an increase (e.g., multi-fold increase) in flushing throughput to the storage device 116.

In some embodiments, the journal 144 and the persistent key-value store may share storage space of the storage device 116 and may not be confined to certain storage regions/addresses. Because of this sharing of storage space, space management functionality may be implemented by the first node 104 for the storage device 116. The space management functionality may track metrics associated with storage utilization by the journal 144. The metrics may relate to a total amount of storage being consumed by the journal 144, a percentage of storage of the block storage device 162 being consumed by the journal 144, a remaining amount of available storage of the block storage device 162, historic amounts of storage of the block storage device 162 consumed by the journal 144, etc.

The space management functionality may provide the metrics to the persistent key-value store, which may use the metrics to determine when to write key-value record pairs from the persistent key-value store to the distributed storage 118. For example, the metrics may indicate a current amount and/or historic amounts of storage of the block storage device 162 consumed by the journal 144 (e.g., the journal 144 may historically consume 150 gigabytes (GB) out of 300 GB of the block storage device 162 on average). The metrics may be used to calculate a remaining amount of storage of the block storage device 162 and/or a predicted amount of subsequent storage of the block storage device 162 that would be consumed. This calculation may be based upon the current amount and/or historic amounts of storage of the block storage device 162 consumed by the journal 144 (e.g., 150 GB consumption), a current amount and/or historic amounts of storage of the block storage device 162 consumed by the persistent key-value store (e.g., 120 GB consumption on average by the persistent key-value store), and/or a size of the block storage device 162 (e.g., 300 GB). In this way, a determination may be made to write key-value record pairs from the persistent key-value store to the distributed storage 118 in order to free up storage space on the block storage device 162 so that the storage space does not run out. For example, once total consumption reaches or is predicted to reach 280 GB, then the key-value record pairs may be written from the persistent key-value store to the distributed storage 118.

The space management functionality may track metrics associated with storage utilization by the persistent key-value store. The metrics may relate to a total amount of storage being consumed by the persistent key-value store, a percentage of storage of the block storage device 162 being consumed by the persistent key-value store, a remaining amount of available storage of the block storage device 162, historic amounts of storage of the block storage device 162 consumed by the persistent key-value store, etc. The space management functionality may provide the metrics to the journal 144, which may be used to determine when to implement a consistency point to store (e.g., flush) data (e.g., logged I/O operations, such as logged write operations and/or other types of operations) from the journal 144 to storage (e.g., replay operations logged within the journal 144 to a storage device in order to clear the logged operations from the journal 144 for space management purposes).

For example, the metrics may indicate a current amount and/or historic amounts of storage of the block storage device 162 consumed by the persistent key-value store (e.g., 120 GB consumption on average by the persistent key-value store). The metrics may be used to calculate a remaining amount of storage of the block storage device 162 (e.g., the remaining amount may correspond to a total storage size of the block storage device 162 minus what storage of the block storage device 162 is currently consumed as indicated by the metrics) and/or a predicted amount of subsequent storage of the block storage device 162 that would be consumed (e.g., a historical average amount of storage of the block storage device 162 consumed, which may be identified by averaging the metrics tracked over time). This calculation may be based upon the current amount and/or historic amounts of storage of the block storage device 162 consumed by the persistent key-value store (e.g., 120 GB consumption), a current amount and/or historic amounts of storage of the block storage device 162 consumed by the journal 144 (e.g., the journal 144 may historically consume 150 GB out of 300 GB of the storage of the block storage device 162 on average), and/or a size of the block storage device 162 (e.g., 300 GB). In this way, a determination may be made to implement the consistency point to store (e.g., flush) data (e.g., logged I/O operations, such as logged write operations and/or other types of operations) from the journal 144 to storage in order to free up storage space of the block storage device 162 so that the storage space does not run out. For example, once total consumption reaches or is predicted to reach a threshold amount (e.g., 2.8 GB), then the consistency point may be triggered. In this way, management of the journal 144 and the persistent key-value store may be aware of each other's storage utilization of storage of the block storage device 162 so that storage space within the block storage device 162 does not become full.

In some embodiments, a journal recovery process may be performed using the journal 144. The journal recovery process may be performed in response to a crash (e.g., the journal recovery process may be performed to recover the first node 104 in response to the first node 104 crashing). In some embodiments, the journal recovery process may comprise performing a journal replay.

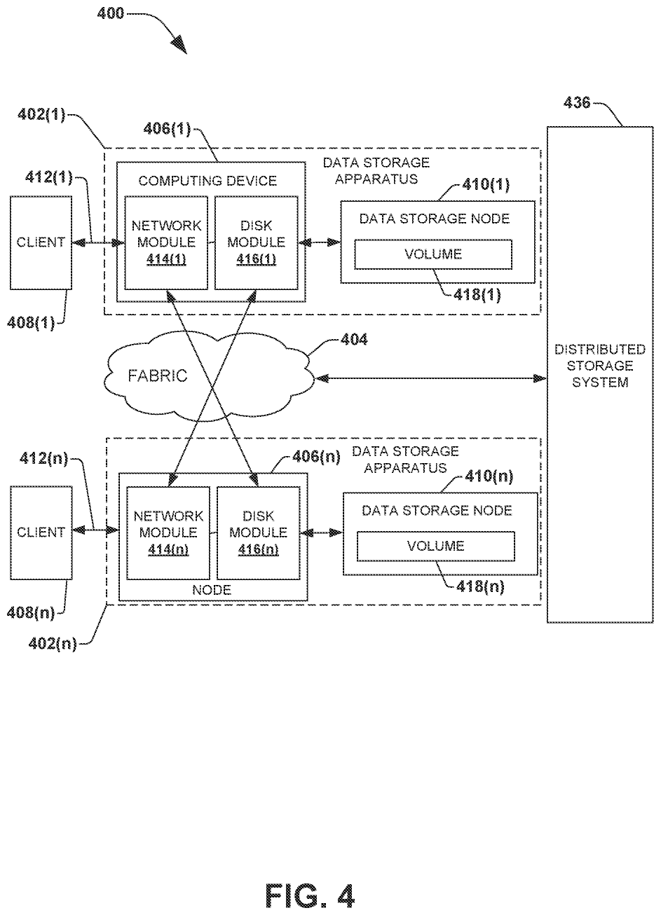

A clustered network environment 400 that may implement one or more aspects of the techniques described and illustrated herein is shown in FIG. 4. The clustered network environment 400 includes data storage apparatuses 402(1)-402(n) that are coupled over a cluster or cluster fabric 404 that includes one or more communication network(s) and facilitates communication between the data storage apparatuses 402(1)-402(n) (and one or more modules, components, etc. therein, such as, computing devices 406(1)-406(n), for example), although any number of other elements or components can also be included in the clustered network environment 400 in other examples.

In accordance with one embodiment of the disclosed techniques presented herein, a journal (e.g., the journal 144) may be implemented for the clustered network environment 400. The journal may be implemented for the computing devices 406(1)-406(n). For example, the journal may be used to implement a primary cache for the computing device 406(1) so that journal data may be cached by the computing device 406(1) within the journal (e.g., the journal data may be associated with I/O operations and/or the journal data may be stored in the journal to log the I/O operations in the journal). Operation of the journal is described further in relation to FIGS. 1A, 1B, 1C, 2, 3, 3A, 3B, and 3C.

In this example, computing devices 406(1)-406(n) can be primary or local storage controllers or secondary or remote storage controllers that provide client devices 408(1)-408(n) with access to data stored within data storage devices 410(1)-410(n) and storage devices of a distributed storage system 436. The computing devices 406(1)-406(n) may be implemented as hardware, software (e.g., a storage virtual machine), or combination thereof. The computing devices 406(1)-406(n) may be used to host containers of a container orchestration platform.

The data storage apparatuses 402(1)-402(n) and/or computing devices 406(1)-406(n) of the examples described and illustrated herein are not limited to any particular geographic areas and can be clustered locally and/or remotely via a cloud network, or not clustered in other examples. Thus, in one example the data storage apparatuses 402(1)-402(n) and/or computing device computing device 406(1)-406(n) can be distributed over a plurality of storage systems located in a plurality of geographic locations (e.g., located on-premise, located within a cloud computing environment, etc.); while in another example a clustered network can include data storage apparatuses 402(1)-402(n) and/or computing device computing device 406(1)-406(n) residing in a same geographic location (e.g., in a single on-site rack).

In the illustrated example, one or more of the client devices 408(1)-408(n), which may be, for example, personal computers (PCs), computing devices used for storage (e.g., storage servers), or other computers or peripheral devices, are coupled to the respective data storage apparatuses 402(1)-402(n) by network connections 412(1)-412(n). Network connections 412(1)-412(n) may include a local area network (LAN) or wide area network (WAN) (i.e., a cloud network), for example, that utilize TCP/IP and/or one or more Network Attached Storage (NAS) protocols, such as a Common Internet File system (CIFS) protocol or a Network File system (NFS) protocol to exchange data packets, a Storage Area Network (SAN) protocol, such as Small Computer System Interface (SCSI) or Fiber Channel Protocol (FCP), an object protocol, such as simple storage service (S3), and/or non-volatile memory express (NVMe), for example.

Illustratively, the client devices 408(1)-408(n) may be general-purpose computers running applications and may interact with the data storage apparatuses 402(1)-402(n) using a client/server model for exchange of information. That is, the client devices 408(1)-408(n) may request data from the data storage apparatuses 402(1)-402(n) (e.g., data on one of the data storage devices 410(1)-410(n) managed by a network storage controller configured to process I/O commands issued by the client devices 408(1)-408(n)), and the data storage apparatuses 402(1)-402(n) may return results of the request to the client devices 408(1)-408(n) via the network connections 412(1)-412(n).

The computing devices 406(1)-406(n) of the data storage apparatuses 402(1)-402(n) can include network or host computing devices that are interconnected as a cluster to provide data storage and management services, such as to an enterprise having remote locations, cloud storage (e.g., a storage endpoint may be stored within storage devices of the distributed storage system 436), etc., for example. Such computing devices 406(1)-406(n) can be attached to the cluster fabric 404 at a connection point, redistribution point, or communication endpoint, for example. One or more of the computing devices 406(1)-406(n) may be capable of sending, receiving, and/or forwarding information over a network communications channel, and could comprise any type of device that meets any or all of these criteria.

In an embodiment, the computing devices 406(1) and 406(n) may be configured according to a disaster recovery configuration whereby a surviving computing device provides switchover access to the data storage devices 410(1)-410(n) in the event a disaster occurs at a disaster storage site (e.g., the computing device computing device 406(1) provides client device 412(n) with switchover data access to data storage devices 410(n) in the event a disaster occurs at the second storage site). In other examples, the computing device computing device 406(n) can be configured according to an archival configuration and/or the computing devices 406(1)-406(n) can be configured based upon another type of replication arrangement (e.g., to facilitate load sharing). Additionally, while two computing devices are illustrated in FIG. 4, any number of computing devices or data storage apparatuses can be included in other examples in other types of configurations or arrangements.

As illustrated in the clustered network environment 400, computing devices 406(1)-406(n) can include various functional components that coordinate to provide a distributed storage architecture. For example, the computing devices 406(1)-406(n) can include network modules 414(1)-414(n) and disk modules 416(1)-416(n). Network modules 414(1)-414(n) can be configured to allow the computing devices 406(1)-406(n) (e.g., network storage controllers) to connect with client devices 408(1)-408(n) over the storage network connections 412(1)-412(n), for example, allowing the client devices 408(1)-408(n) to access data stored in the clustered network environment 400.

Further, the network modules 414(1)-414(n) can provide connections with one or more other components through the cluster fabric 404. For example, the network module 414(1) of computing device computing device 406(1) can access the data storage device 410(n) by sending a request via the cluster fabric 404 through the disk module 416(n) of computing device computing device 406(n) when the computing device computing device 406(n) is available. Alternatively, when the computing device computing device 406(n) fails, the network module 414(1) of computing device computing device 406(1) can access the data storage device 410(n) directly via the cluster fabric 404. The cluster fabric 404 can include one or more local and/or wide area computing networks (i.e., cloud networks) embodied as Infiniband, Fibre Channel (FC), or Ethernet networks, for example, although other types of networks supporting other protocols can also be used.

Disk modules 416(1)-416(n) can be configured to connect data storage devices 410(1)-410(n), such as disks or arrays of disks, SSDs, flash memory, or some other form of data storage, to the computing devices 406(1)-406(n). Often, disk modules 416(1)-416(n) communicate with the data storage devices 410(1)-410(n) according to the SAN protocol, such as SCSI or FCP, for example, although other protocols can also be used. Thus, as seen from an operating system on computing devices 406(1)-406(n), the data storage devices 410(1)-410(n) can appear as locally attached. In this manner, different computing devices 406(1)-406(n), etc. may access data blocks, files, or objects through the operating system, rather than expressly requesting abstract files.

While the clustered network environment 400 illustrates an equal number of network modules 414(1)-414(n) and disk modules 416(1)-416(n), other examples may include a differing number of these modules. For example, there may be a plurality of network and disk modules interconnected in a cluster that do not have a one-to-one correspondence between the network and disk modules. That is, different computing devices can have a different number of network and disk modules, and the same computing device computing device can have a different number of network modules than disk modules.

Further, one or more of the client devices 408(1)-408(n) can be networked with the computing devices 406(1)-406(n) in the cluster, over the storage connections 412(1)-412(n). As an example, respective client devices 408(1)-408(n) that are networked to a cluster may request services (e.g., exchanging of information in the form of data packets) of computing devices 406(1)-406(n) in the cluster, and the computing devices 406(1)-406(n) can return results of the requested services to the client devices 408(1)-408(n). In one example, the client devices 408(1)-408(n) can exchange information with the network modules 414(1)-414(n) residing in the computing devices 406(1)-406(n) (e.g., network hosts) in the data storage apparatuses 402(1)-402(n).

In one example, the storage apparatuses 402(1)-402(n) host aggregates corresponding to physical local and remote data storage devices, such as local flash or disk storage in the data storage devices 410(1)-410(n), for example. One or more of the data storage devices 410(1)-410(n) can include mass storage devices, such as disks of a disk array. The disks may comprise any type of mass storage devices, including but not limited to magnetic disk drives, flash memory, and any other similar media adapted to store information, including, for example, data and/or parity information.

The aggregates include volumes 418(1)-418(n) in this example, although any number of volumes can be included in the aggregates. The volumes 418(1)-418(n) are virtual data stores or storage objects that define an arrangement of storage and one or more file systems within the clustered network environment 400. Volumes 418(1)-418(n) can span a portion of a disk or other storage device, a collection of disks, or portions of disks, for example, and typically define an overall logical arrangement of data storage. In one example, volumes 418(1)-418(n) can include stored user data as one or more files, blocks, or objects that may reside in a hierarchical directory structure within the volumes 418(1)-418(n).

Volumes 418(1)-418(n) are typically configured in formats that may be associated with particular storage systems, and respective volume formats typically comprise features that provide functionality to the volumes 418(1)-418(n), such as providing the ability for volumes 418(1)-418(n) to form clusters, among other functionality. Optionally, one or more of the volumes 418(1)-418(n) can be in composite aggregates and can extend between one or more of the data storage devices 410(1)-410(n) and one or more of the storage devices of the distributed storage system 436 to provide tiered storage, for example, and other arrangements can also be used in other examples.

In one example, to facilitate access to data stored on the disks or other structures of the data storage devices 410(1)-410(n), a file system may be implemented that logically organizes the information as a hierarchical structure of directories and files. In this example, respective files may be implemented as a set of disk blocks of a particular size that are configured to store information, whereas directories may be implemented as specially formatted files in which information about other files and directories are stored.

Data can be stored as files or objects within a physical volume and/or a virtual volume, which can be associated with respective volume identifiers. The physical volumes correspond to at least a portion of physical storage devices, such as the data storage devices 410(1)-410(n) (e.g., a Redundant Array of Independent (or Inexpensive) Disks (RAID system)) whose address, addressable space, location, etc. does not change. Typically, the location of the physical volumes does not change in that the range of addresses used to access it generally remains constant.

Virtual volumes, in contrast, can be stored over an aggregate of disparate portions of different physical storage devices. Virtual volumes may be a collection of different available portions of different physical storage device locations, such as some available space from disks, for example. It will be appreciated that since the virtual volumes are not “tied” to any one particular storage device, virtual volumes can be said to include a layer of abstraction or virtualization, which allows it to be resized and/or flexible in some regards.

Further, virtual volumes can include one or more logical unit numbers (LUNs), directories, Qtrees, files, and/or other storage objects, for example. Among other things, these features, but more particularly the LUNs, allow the disparate memory locations within which data is stored to be identified, for example, and grouped as data storage unit. As such, the LUNs may be characterized as constituting a virtual disk or drive upon which data within the virtual volumes is stored within an aggregate. For example, LUNs are often referred to as virtual drives, such that they emulate a hard drive, while they actually comprise data blocks stored in various parts of a volume.

In one example, the data storage devices 410(1)-410(n) can have one or more physical ports, wherein each physical port can be assigned a target address (e.g., SCSI target address). To represent respective volumes, a target address on the data storage devices 410(1)-410(n) can be used to identify one or more of the LUNs. Thus, for example, when one of the computing devices 406(1)-406(n) connects to a volume, a connection between the one of the computing devices 406(1)-406(n) and one or more of the LUNs underlying the volume is created.

Respective target addresses can identify multiple of the LUNs, such that a target address can represent multiple volumes. The I/O interface, which can be implemented as circuitry and/or software in a storage adapter or as executable code residing in memory and executed by a processor, for example, can connect to volumes by using one or more addresses that identify the one or more of the LUNs.

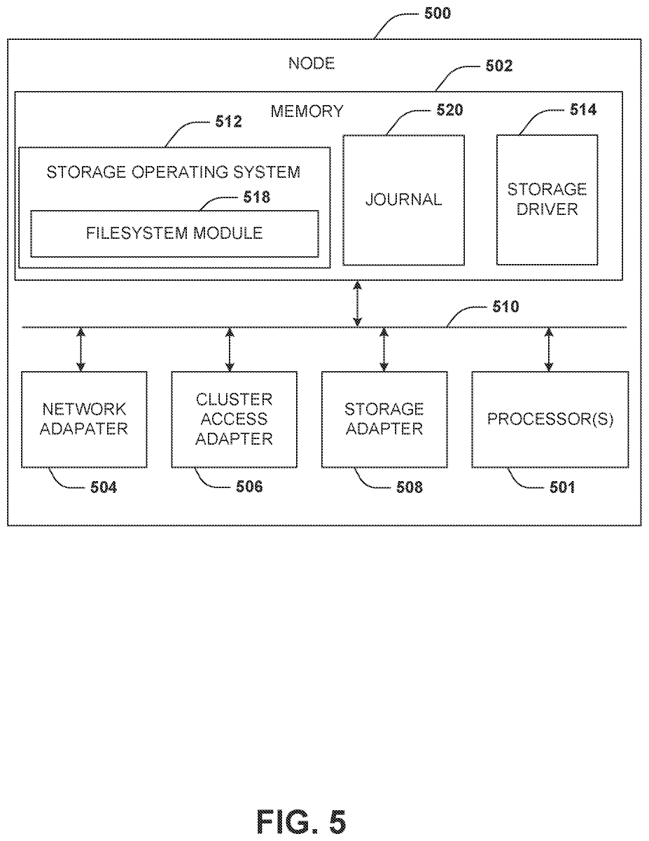

Referring to FIG. 5, a node 500 in this particular example includes processor(s) 501, a memory 502, a network adapter 504, a cluster access adapter 506, and a storage adapter 508 interconnected by a system bus 510. In other examples, the node 500 comprises a virtual machine, such as a virtual storage machine.

The node 500 also includes a storage operating system 512 installed in the memory 502 that can, for example, implement a RAID data loss protection and recovery scheme to optimize reconstruction of data of a failed disk or drive in an array, along with other functionality such as deduplication, compression, snapshot creation, data mirroring, synchronous replication, asynchronous replication, encryption, etc.

The network adapter 504 in this example includes the mechanical, electrical and signaling circuitry needed to connect the node 500 to one or more of the client devices over network connections, which may comprise, among other things, a point-to-point connection or a shared medium, such as a local area network. In some examples, the network adapter 504 further communicates (e.g., using TCP/IP) via a cluster fabric and/or another network (e.g., a WAN) (not shown) with storage devices of a distributed storage system to process storage operations associated with data stored thereon.

The storage adapter 508 cooperates with the storage operating system 512 executing on the node 500 to access information requested by one of the client devices (e.g., to access data on a data storage device managed by a network storage controller). The information may be stored on any type of attached array of writeable media such as magnetic disk drives, flash memory, and/or any other similar media adapted to store information.

In the exemplary data storage devices, information can be stored in data blocks on disks. The storage adapter 508 can include I/O interface circuitry that couples to the disks over an I/O interconnect arrangement, such as a storage area network (SAN) protocol (e.g., Small Computer System Interface (SCSI), Internet SCSI (iSCSI), hyperSCSI, Fiber Channel Protocol (FCP)). The information is retrieved by the storage adapter 508 and, if necessary, processed by the processor(s) 501 (or the storage adapter 508 itself) prior to being forwarded over the system bus 510 to the network adapter 504 (and/or the cluster access adapter 506 if sending to another node computing device in the cluster) where the information is formatted into a data packet and returned to a requesting one of the client devices and/or sent to another node computing device attached via a cluster fabric. In some examples, a storage driver 514 in the memory 502 interfaces with the storage adapter to facilitate interactions with the data storage devices.

The storage operating system 512 can also manage communications for the node 500 among other devices that may be in a clustered network, such as attached to the cluster fabric. Thus, the node 500 can respond to client device requests to manage data on one of the data storage devices or storage devices of the distributed storage system in accordance with the client device requests.

The file system module 518 of the storage operating system 512 can establish and manage one or more file systems including software code and data structures that implement a persistent hierarchical namespace of files and directories, for example. As an example, when a new data storage device (not shown) is added to a clustered network system, the file system module 518 is informed where, in an existing directory tree, new files associated with the new data storage device are to be stored. This is often referred to as “mounting” a file system.

In the example node 500, memory 502 can include storage locations that are addressable by the processor(s) 501 and adapters 504, 506, and 508 for storing related software application code and data structures. The processor(s) 501 and adapters 504, 506, and 508 may, for example, include processing elements and/or logic circuitry configured to execute the software code and manipulate the data structures.

The storage operating system 512, portions of which are typically resident in the memory 502 and executed by the processor(s) 501, invokes storage operations in support of a file service implemented by the node 500. Other processing and memory mechanisms, including various computer readable media, may be used for storing and/or executing application instructions pertaining to the techniques described and illustrated herein. For example, the storage operating system 512 can also utilize one or more control files (not shown) to aid in the provisioning of virtual machines.

In this particular example, the node 500 also includes a module configured to implement the techniques described herein, as discussed above and further below. In accordance with one embodiment of the techniques described herein, a journal 520 (e.g., the journal 144) may be implemented for node 500. The journal 520 may be located within memory 502, such as memory of the storage device 116. The journal 520 may be used to implement a primary cache for the node 500 so that journal data may be cached by the node 500 within the journal 520 (e.g., the journal data may be associated with I/O operations and/or the journal data may be stored in the journal to log the I/O operations in the journal). Operation of the journal is described further in relation to FIGS. 1A, 1B, 1C, 2, 3, 3A, 3B, and 3C.

The examples of the technology described and illustrated herein may be embodied as one or more non-transitory computer or machine readable media, such as the memory 502, having machine or processor-executable instructions stored thereon for one or more aspects of the present technology, which when executed by processor(s), such as processor(s) 501, cause the processor(s) to carry out the steps necessary to implement the methods of this technology, as described and illustrated with the examples herein. In some examples, the executable instructions are configured to perform one or more steps of a method described and illustrated later.

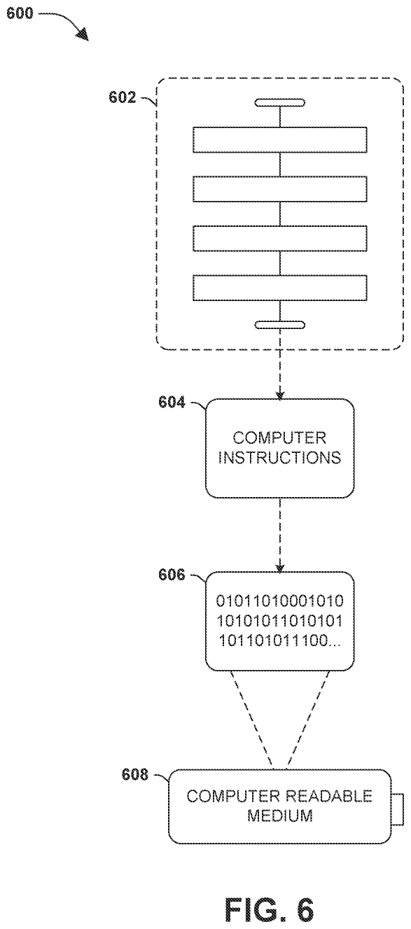

Still another embodiment involves a computer-readable medium 600 comprising processor-executable instructions configured to implement one or more of the techniques presented herein. An example embodiment of a computer-readable medium or a computer-readable device that is devised in these ways is illustrated in FIG. 6, wherein the implementation comprises a computer-readable medium 608, such as a compact disc-recordable (CD-R), a digital versatile disc-recordable (DVD-R), flash drive, a platter of a hard disk drive, etc., on which is encoded computer-readable data 606. This computer-readable data 606, such as binary data comprising at least one of a zero or a one, in turn comprises processor-executable computer instructions 604 configured to operate according to one or more of the principles set forth herein. In some embodiments, the processor-executable computer instructions 604 are configured to perform a method 602, such as at least some of the example method 200 of FIG. 2, at least some of the example method 300 of FIG. 3A, at least some of the example method 325 of FIG. 3B and/or at least some of the example method 350 of FIG. 3C, for example. In some embodiments, the processor-executable computer instructions 604 are configured to implement a system, such as at least some of the exemplary distributed storage architecture 100 of FIGS. 1A-1C, for example. Many such computer-readable media are contemplated to operate in accordance with the techniques presented herein.

In an embodiment, the described methods and/or their equivalents may be implemented with computer executable instructions. Thus, in an embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on. In an embodiment, a computing device is implemented with one or more executable algorithms that are configured to perform any of the disclosed methods.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), electrically erasable programmable read-only memory (EEPROM) and/or flash memory, compact disk read only memory (CD-ROM)s, CD-Rs, compact disk re-writeable (CD-RW)s, DVDs, cassettes, magnetic tape, magnetic disk storage, optical or non-optical data storage devices and/or any other medium which can be used to store data.

Some examples of the claimed subject matter have been described with reference to the drawings, where like reference numerals are generally used to refer to like elements throughout. In the description, for purposes of explanation, numerous specific details are set forth in order to provide an understanding of the claimed subject matter. It may be evident, however, that the claimed subject matter may be practiced without these specific details. Nothing in this detailed description is admitted as prior art.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard application or engineering techniques to produce software, firmware, hardware, or any combination thereof to control a computer to implement the disclosed subject matter. The term “article of manufacture” as used herein is intended to encompass a computer application accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, an application, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system, comprising:
a node, of a distributed cluster of nodes hosted within a container orchestration platform, configured to store data across distributed storage managed by the distributed cluster of nodes;
a journal hosted as a primary cache for the node,
wherein a plurality of input/output (I/O) operations of a plurality of clients are logged within the journal;
a storage device configured to store the journal as the primary cache, wherein the storage device comprises:
a block storage device; and
a cache;
a storage management system configured to:
store a first set of journal data, indicative of a first I/O operation of the plurality of I/O operations, in the block storage device without storing the first set of journal data in the cache; and
store a second set of journal data, indicative of a second I/O operation of the plurality of I/O operations, in the block storage device and the cache.

2. The system of claim 1, wherein the storage management system is configured to:
determine one or more characteristics associated with the first set of journal data, wherein the one or more characteristics comprise at least one of:
a type of I/O operation of the first I/O operation;
a size of the first set of journal data; or
a client, of the plurality of clients, associated with the first I/O operation; and
determine, based upon the one or more characteristics, not to store the first set of journal data in the cache.

3. The system of claim 2, wherein the storage management system is configured to use the one or more characteristics to determine whether or not to store the first set of journal data in the cache when a sync transfer mode is implemented for transferring sets of data to the journal.

4. The system of claim 1, wherein the storage management system is configured to:
determine one or more characteristics associated with the second set of journal data, wherein the one or more characteristics comprise at least one of:
a type of I/O operation of the second I/O operation;
a size of the second set of journal data; or
a client, of the plurality of clients, associated with the second I/O operation; and
determine, based upon the one or more characteristics, to store the second set of journal data in the block storage device and in the cache.

5. The system of claim 4, wherein the storage management system is configured to use the one or more characteristics to determine whether or not to store the second set of journal data in the cache when a sync transfer mode is implemented for transferring sets of data to the journal.

6. The system of claim 1, wherein the storage management system is configured to:
determine a status of a region, of the block storage device, in which the first set of journal data is stored; and
determine, based upon the status being dormant, not to store the first set of journal data in the cache.

7. The system of claim 6, wherein the storage management system is configured to use the status to determine whether or not to store the first set of journal data in the cache when an async transfer mode is implemented for transferring sets of data to the journal.

8. The system of claim 1, wherein the storage management system is configured to:
determine a status of a region, of the block storage device, in which the second set of journal data is stored; and
determine, based upon the status being active, to store the second set of journal data in the cache.

9. The system of claim 8, wherein the storage management system is configured to use the status to determine whether or not to store the second set of journal data in the cache when an async transfer mode is implemented for transferring sets of data to the journal.

10. The system of claim 1, comprising:
a data management system configured to implement a plurality of flushing threads to facilitate concurrent data transfers from clients of the plurality of clients to the journal.

11. The system of claim 1, wherein the storage device is configured to store a persistent key-value store,
wherein the data is cached as key-value record pairs within the persistent key-value store for read and write access until written in a distributed manner across the distributed storage.

12. The system of claim 11, comprising space management functionality configured to:
track metrics associated with storage utilization by at least one of the journal or the persistent key-value store, wherein the metrics are used to determine when to store data from the journal to storage.

13. A method, comprising:
hosting, on a storage device, a journal as a primary cache for a node, of a distributed cluster of nodes hosted within a container orchestration platform, configured to store data across distributed storage managed by the distributed cluster of nodes, wherein:
the storage device comprises a block storage device and a cache; and
a plurality of input/output (I/O) operations of a plurality of clients are logged within the journal;
determining a first status of a first region, of the block storage device, in which a first set of journal data, of the journal, is stored, wherein the first set of journal data is indicative of a first I/O operation of the plurality of I/O operations;
storing the first set of journal data in the cache based upon the first status being active; and
providing byte-addressable access to the first set of journal data of the journal when the first set of journal data is stored in the cache.

14. The method of claim 13, comprising:
determining a second status of a second region, of the block storage device, in which a second set of journal data, of the journal, is stored; and
determining not to store the second set of journal data in the cache based upon the second status being dormant.

15. The method of claim 13, wherein the first status of the first region is used to determine whether or not to store the first set of journal data in the cache when an async transfer mode is implemented for transferring sets of data to the journal.

16. The method of claim 13, comprising:
facilitating concurrent data transfers, from clients of the plurality of clients to the journal, using a plurality of flushing threads implemented by a data management system.

17. A non-transitory machine readable medium comprising instructions, which when executed by a machine, causes the machine to perform operations, the operations comprising:
hosting, on a storage device, a journal as a primary cache for a node, of a distributed cluster of nodes hosted within a container orchestration platform, configured to store data across distributed storage managed by the distributed cluster of nodes, wherein:
the storage device comprises a block storage device and a cache; and
a plurality of input/output (I/O) operations of a plurality of clients are logged within the journal;
determining one or more characteristics associated with a first I/O operation to be logged in the journal, wherein the one or more characteristics comprise at least one of:
a type of I/O operation of the first I/O operation;
a size of a first set of journal data indicative of the first I/O operation; or
a client, of the plurality of clients, associated with the first I/O operation;
storing the first set of journal data in the cache and the block storage device based upon the one or more characteristics; and
providing byte-addressable access to the first set of journal data of the journal when the first set of journal data is stored in the cache.

18. The non-transitory machine readable medium of claim 17, the operations comprising:
determining one or more second characteristics associated with a second I/O operation to be logged in the journal, wherein the one or more second characteristics comprise at least one of:
a second type of I/O operation of the second I/O operation;
a second size of a second set of journal data indicative of the second I/O operation; or
a second client, of the plurality of clients, associated with the second I/O operation; and
determining, based upon the one or more second characteristics, to store the second set of journal data in the block storage device and not to store the second set of journal data in the cache.

19. The non-transitory machine readable medium of claim 17, wherein the one or more characteristics are used to determine whether or not to store the first set of journal data in the cache when a sync transfer mode is implemented for transferring sets of data to the journal.

20. The non-transitory machine readable medium of claim 17, wherein storing the first set of journal data in the cache and the block storage device is performed based upon a determination that the size of the first set of journal data is smaller than a threshold size.
